(19) United States
(12) Patent Application Publication
(10) Pub. No.: US 2024/0356972 A1
(43) Pub. Date: Oct. 24, 2024

(54) COMPUTER NETWORK SECURITY DEVICE

(71) Applicant: Gorgon IP Pty. Ltd., Victoria (AU)

(72) Inventors: Bjarne MATZEN, Victoria (AU); Reina Patricia ESCOBARZELAYA, Victoria (AU)

(21) Appl. No.: 18/682,337

(22) PCT Filed: Aug. 9, 2022
(86) PCT No.: PCT/AU2022/050870

§ 371 Date: Feb. 8, 2024

Related U.S. Application Data
(60) Provisional application No. 63/231,191, filed on Aug. 9, 2021.

(51) Int. Cl. H04L 9/40; H04L 41/14; H04L 41/40

(52) U.S. Cl. CPC H04L 63/1491; H04L 41/145; H04L 41/40; H04L 63/1458

(57) ABSTRACT

A simulator device for detecting a possible network intrusion in a network. The simulator device comprises a virtual network communications module configured to simulate one or more virtual device simulations. Each virtual device simulation respectively provides a virtual decoy for a possible network intrusion. The simulator device also comprises a threat detection module configured to detect the possible network intrusion by detecting received data intended for any one or more of the virtual device simulations.

### TECHNICAL FIELD

The embodiments described herein broadly relate to a device and a method for detecting a possible network intrusion in a network.

### BACKGROUND

Networks are often prone to cyber attacks from external parties with malicious intentions. This is especially problematic in the case of a home or small office network where there may not be an administrator or user on hand with the specialist knowledge or expertise to be able to detect when there is a network intrusion, and moreover would not be able to remedy the situation to minimise damage to the network.

### SUMMARY

In one aspect, there is provided a simulator device for detecting a possible network intrusion in a network, comprising: a virtual network communications module configured to simulate one or more virtual device simulations, each virtual device simulation respectively providing a virtual decoy for a possible network intrusion; and a threat detection module configured to detect the possible network intrusion by detecting received data intended for any one or more of the virtual device simulations.

In some embodiments, the virtual decoy is perceived by the possible network instruction to be an active device connected into the network, optionally communicating with another device.

In some embodiments, the virtual network communications module is configured to simulate one or more virtual device simulations by generating chatter on the network for each respective virtual device simulation.

In some embodiments, the virtual device simulation is a simulation of a device connected into the network.

In some embodiments, the device connected into the network is a device other than the simulator device.

In some embodiments, the preceding claims wherein there are more virtual device simulations than there are devices connected into the network.

In some embodiments, the virtual network communications module is configured to simulate a plurality of virtual device simulations concurrently, optionally up to 25 virtual device simulations.

In some embodiments, the simulator device has a low power rating, optionally a power rating of about 10 Watts.

In some embodiments, the simulator device further comprises a data input connector.

In some embodiments, the data input connector is a data input network connector for connecting the simulator device into the network, such that the simulator device is configured to receive data through the data input network connector.

In some embodiments, the simulator device is further configured to respond to the detected possible network intrusion.

In some embodiments, the simulator device further comprises a threat response module configured to respond to the detected possible network intrusion.

In some embodiments, the threat response module is configured to respond by any one or more of:
issuing an alert
packet monitoring
packet blocking

In some embodiments, the threat response module is configured to respond by counter-attacking the detected possible network intrusion, optionally using a Denial of Service counter-attack.

In some embodiments, the at least one of the one or more of the virtual device simulation comprises a respective virtual device simulation identifier.

In some embodiments, the respective virtual device simulation identifier is similar to an identifier of a device connected into the network.

In some embodiments, the respective virtual device simulation identifier is not identical to the identifier.

In some embodiments, at least one of the one or more of the virtual device simulation identifier is or comprises a respective virtual MAC address and/or a respective virtual IP address.

In some embodiments, the respective virtual MAC address is a similar to an MAC address of a device connected into the network.

In some embodiments, the respective virtual MAC address is not identical to the MAC address of the device connected into the network.

In some embodiments, the respective virtual IP address is a similar to an IP address of a device connected into the network.

In some embodiments, the respective virtual IP address is not identical to the IP address of the device connected into the network.

In some embodiments, the device connected into the network is a device other than the simulator device.

In some embodiments, the simulator device further comprises a packet sniffer for filtering received data received by the simulator device via the network connector.

In some embodiments, the packet sniffer is configured to filter through received data intended for any one or more of the virtual device simulations.

In some embodiments, the packet sniffer is configured to filter through data by: intercepting received data; and forwarding received data to the threat detection module for data analysis.

In some embodiments, the possible network intrusion is detected following a determination by the threat detection module.

In some embodiments, the simulator device is further configured to generate any one or more of the virtual device simulations.

In some embodiments, the virtual network communications module is further configured to generate any one or more of the virtual device simulations.

In some embodiments, the generated virtual device simulations is generated based on a device connected into the network.

In some embodiments, the device connected into the network is a device other than the simulator device.

In some embodiments, the virtual network communications module is further configured to scan for one or more other devices connected into the network in order to generate any one or more of the virtual device simulations that is generated based on the device connected into the network.

In some embodiments, the virtual network communications module generates any one or more of the virtual device simulations using machine learning to learn behaviour of the device connected into the network.

In some embodiments, the virtual network communications module generates any one or more of the virtual device simulations comprising a step of generating a virtual device simulation identifier for the respective virtual device simulation.

In some embodiments, the virtual device simulation identifier is or comprises a MAC address and/or IP address for the respective virtual device simulation.

In some embodiments, the MAC address is generated based on one or more MAC addresses of the respective one or more devices connected into the network.

In some embodiments, the generated virtual MAC address is a similar to an MAC address of a device connected into the network.

In some embodiments, the generated virtual MAC address is not identical to the MAC address of the device connected into the network.

In some embodiments, the IP address is generated based on one or more IP addresses of the respective one or more devices connected into the network.

In some embodiments, the respective generated virtual IP address is a similar to an IP address of a device connected into the network.

In some embodiments, the generated virtual IP address is not identical to the IP address of the device connected into the network.

In some embodiments, the device connected into the network is a device other than the simulator device.

In some embodiments, the simulator device further comprises a local on-demand web server.

In some embodiments, the simulator device further comprises an external communications manager.

In some embodiments, the simulator device further comprises an alert handler.

In some embodiments, the simulator device further comprises a local on-demand web server.

In some embodiments, the simulator device further comprises a monitoring and reporting module.

In some embodiments, the simulator device further comprises a physical I/O handler.

In some embodiments, the simulator device is configured to connect to an administrative platform.

In another aspect, there is provided a network comprising one or more simulator devices according to a first aspect.

In another aspect, there is provided a method of detecting a possible network intrusion in a network comprising the steps of: simulating one or more virtual device simulations, each virtual device simulation respectively providing a virtual decoy for a possible network intrusion; receiving data; and detecting the possible network intrusion by detecting received data intended for any one or more of the virtual device simulations.

In some embodiments, the method further comprises the step of generating any one or more of the virtual device simulations.

In some embodiments, the method further comprises the step of responding to the detected possible network intrusion.

In some embodiments, the step of responding is or comprises counter-attacking the detected possible network intrusion, optionally using a Denial of Service counter-attack.

In some embodiments, the virtual device simulations are being simulated concurrently on a low powered device, preferably with a rating of up to about 250 Watts, more preferably with a power rating of about 10 Watts.

In this specification, the terms “simulation device” and “simulator device” are interchangeable, and may refer to any device that comprising the features and/or functions of any one of the simulation device embodiments described herein, but may comprise additional features and/or functions, including additional features and/or functions that may be associated with other devices, such as a router, a switch, server, computer, mobile telephone, and the like for example. That is, any device may be considered a simulation device if they have the features and/or are configured to perform the functions of any one of the simulation device embodiments as described herein.

In this specification, the term “virtual device simulation” refers to a virtual simulation (simulated by the simulation device) that appears as a device connected into a network. The virtual device simulation as described in this specification play the role of a virtual decoy.

In this specification, the term “(virtual) decoy” is a term of art referring to the act of mimicking something else in order to attract cyber threats.

In this specification, the terms “network intrusion”, “threat”, “cyber attack” are considered to have the same meaning and these terms are therefore interchangeable with each other.

In this specification, reference to “user” is a reference to a human being. References to the term “user” may be used in the context of a natural person setting up, using, or monitoring the simulation device as described, unless the context dictates otherwise.

### BRIEF DESCRIPTION OF THE DRAWINGS

FIG. 1A is an overview of a network including an exemplary simulation device.

FIG. 1B a general embodiment of a simulation device.

FIG. 1C a flowchart illustrating an exemplary method.

FIG. 2A-C show various embodiments of the physical design of the simulation device.

FIG. 3 shows an exemplary schematic diagram of the simulation device electronics.

FIG. 4A-B shows an exemplary software architecture of the simulation device and the administrative platform.

FIG. 5 shows an exemplary device software architecture of the simulation device.

FIG. 6 shows an exemplary embodiment of a simulation device comprising a physical I/O handler module handling various interactions.

FIG. 7A-B show exemplary embodiments of a manufacturing server for configuring one or more simulation devices.

FIG. 8A-B show exemplary priming and quality assurance methods of configuring a simulation device.

FIG. 9 shows an exemplary network including two simulation devices.

### DETAILED DESCRIPTION

The following modes, features or aspects, given by way of example only, are described in order to provide a more precise understanding of the subject matter of a preferred embodiment or embodiments.

### 1. OVERVIEW

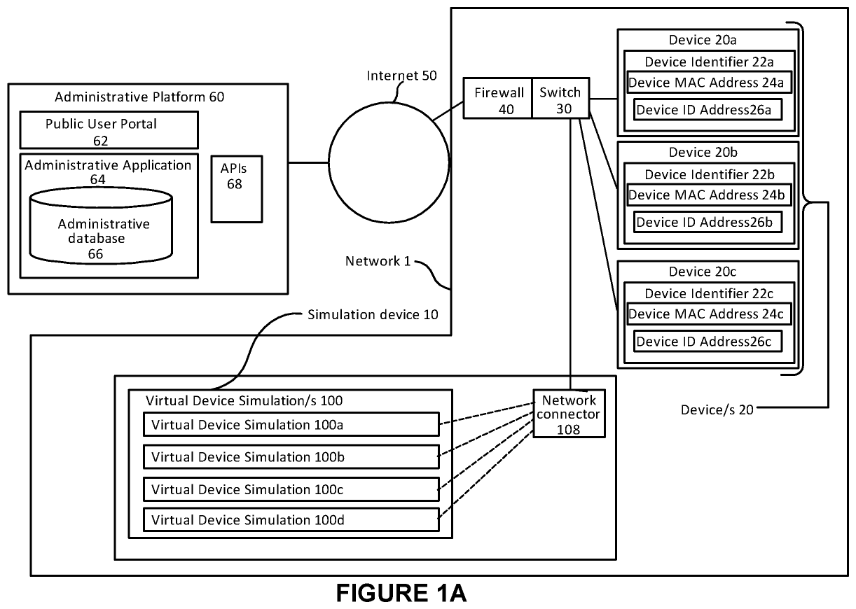

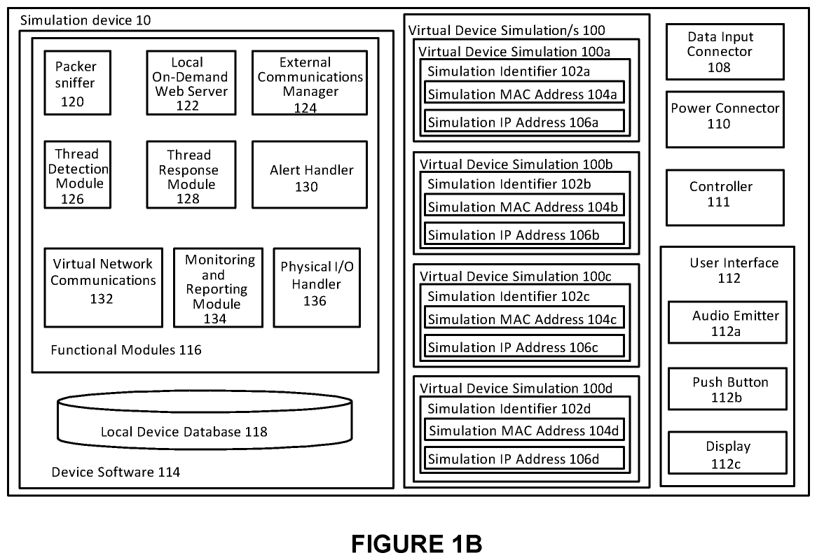

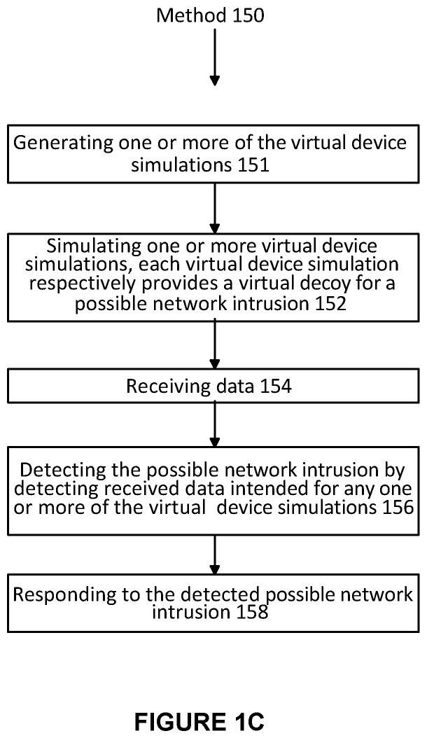

An overview of the network 1 and the simulation device 10 that is connected to the network 1 will be discussed with reference to FIGS. 1A and 1B.

FIG. 1A shows an overview of a network. The network 1 has a simulation device 10 as well as one or more other devices 20 other than the simulation device 10 connected into it. In the example shown in FIG. 1A, there are three such devices 20a-c. Some examples of devices 20 may include any type of electronic device such as computers (which may be a PC desktop or a laptop), mobile telephones (such as smartphones), printers, servers, sub-network (such as an intranet), firewall, router, switch, or the like. The simulation device 10, as well as devices 20a-c can be connected to a switch or router 30. The network 1 can also have a firewall 40 and/or a router (not shown) that enables the devices in the network 1 to be connected to the internet 50. For example, the simulation device 10 can be connected to the internet 50 in order to access extra functionality provided by the administrative platform 60, which may be hosted on a cloud platform for example.

The provision of a simulation device 10 in a network 1 assists with providing security to the network 1, and in particular providing security to the other devices 20a-c connected to the network 1. This is because the simulation device 10 can be used to detect a possible network intrusion in a network 1 the simulator device 10 is connected to. This is done by having the simulation device 10 configured to simulate one or more virtual device simulations (such as virtual device simulations 100a, 100b, 100c, and 100d for example). Each virtual device simulation is simulated as if it is yet a further device that is connected into the network 1. Each virtual device simulation provides a virtual decoy for the possible network intrusion. That is, each virtual device simulation is assumed to be left alone during normal operation of the simulation device 10 such that if the simulation device detects data intended for a virtual device simulation, this signals an attempt to interact with a virtual device simulation (such as an attempt to make contact with the virtual device simulation for example) and an indication that a possible network intrusion is present in the network. The possible network intrusion may be a genuine network intrusion (that may be destructive in nature), or an (approved) sanctioned intrusion (that is non-malicious in nature).

In the example shown in FIGS. 1A and 1B, there are four virtual device simulations 100a-d and three devices 20a-c connected into the network, so in this particular example, there are more virtual device simulations than there are devices (other than the simulation device 10) that are connected into the network. Devices 20a-c may be referred to as a “real device” throughout to avoid confusion with other terms such as “virtual device simulation” or “simulation device”. As it can be expected that a possible network intrusion may attempt to interact with a plurality of devices, it is preferable (but not essential) that there are more virtual device simulations than there are devices (other than the simulation device 10) that are connected into the network so that there is a greater likelihood of the simulator device 10 detecting a possible network intrusion. If the simulator device 10 detects data intended for any one or more of the virtual device simulations (for example an attempt is made to contact one or more virtual device simulations) then this is an indication that there is a possible network intrusion. Action can then be taken to respond to the possible network intrusion, for example to mitigate damage done by the possible network instruction and/or to restore the integrity of the network so that it is secure. For example, an alert could be issued to a user, and/or the simulation device 10 could counterattack the threat source.

Although FIG. 1A shows a single simulator device 1 connected into the network, it is possible for there to be a plurality of simulator devices connected into the network.

Although devices 20 can each be individual devices, it is possible for any one of these devices 20 to refer to plurality of devices. For example, any one of devices 20a-c could refer to a plurality of devices that may or may not form (part of) a sub-network (such as an intranet network for example).

Additionally, while simulation device 10 and devices 20a-c are shown to be connected into a common network 1, any one of these devices may additionally be part of separate sub-networks that form the network 1 in some instances.
For example, the simulation device 10 shown in FIG. 1 may be also be connected into a sub-network comprising a router and firewall (such as an intranet network for example), such that there is an intermediary switch and firewall such that simulation device 10 and switch 30 are connected indirectly. In such example, the simulation device 10 may protect other devices 20 also connected into the network 1 but are not necessarily connected within the same sub-network that simulation device 10 is located in.
Additionally, or alternatively, any one of devices 20a-c shown in FIG. 1 may also be connected into a (separate) sub-network comprising a router and firewall (such as an intranet network for example), such that there is an intermediary switch and firewall such that the device 20 and switch 30 are connected indirectly. In such example, the simulation device 10 may protect such device 20 as they both connect into a common network 1, even though the device 20 is also part of a sub-network within the network 1.

Although the simulation device 10 is shown as a separate device to other devices in the example used in FIG. 1A, the term “simulation device” is intended to also refer to any device comprising the features and/or functions of any one of the simulation device embodiments described in this specification. For example, some embodiments of the simulation device may be one or more of: a router, switch, server, computer, mobile telephone, and the like.

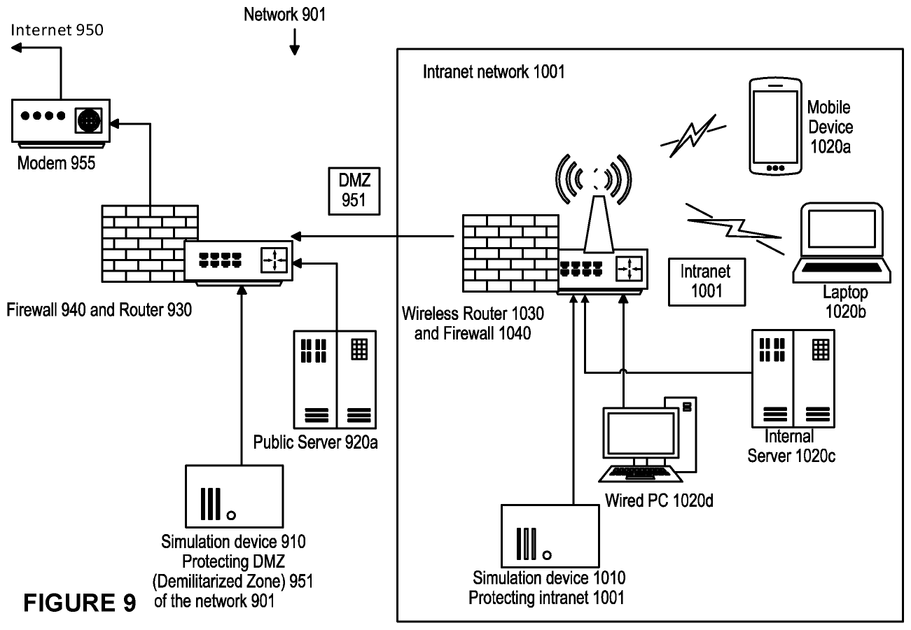

These examples will be discussed further in detail later with respect to FIG. 9.

### 1.1. GENERAL EMBODIMENTS

General embodiments of the simulation device 10 will now be described.

FIG. 1B shows a general embodiment of the simulation device 10. FIG. 1B can be considered an enlarged view of the simulation device 10 shown in FIG. 1A. As already shown in FIG. 1A, the simulation device 10 is configured to simulate one or more virtual device simulation/s 100. In the example shown in FIGS. 1A-B, there are three virtual device simulations 100a-c being simulated on the simulation device 10. Each virtual device simulation may comprise a virtual device simulation identifier, which could comprise or be a virtual device simulation MAC address and/or a virtual device simulation IP address. In the example shown in FIGS. 1A and 1B, virtual device simulation 100a comprises a virtual device simulation identifier 102a (which includes virtual device simulation MAC address 104a and a virtual device simulation IP address 106a), while virtual device simulation 100b comprises a virtual device simulation identifier 102b (which includes virtual device simulation MAC address 104b and a virtual device simulation IP address 106b), while virtual device simulation 100c comprises a virtual device simulation identifier 102c (which includes virtual device simulation MAC address 104c and a virtual device simulation IP address 106c), while virtual device simulation 106a comprises a virtual device simulation identifier 106b (which includes virtual device simulation MAC address 106c and a virtual device simulation IP address 106d).

Although FIGS. 1A and 1B show four virtual device simulations, there may be more or fewer number of virtual device simulations, which may be simulated concurrently. In some examples, there may be up to 5 virtual device simulations. In some examples, there may be up to 10 virtual device simulations. In some examples, there may be up to 15 virtual device simulations. In some examples, there may be up to 20 virtual device simulations. In some examples, there may be up to 25 virtual device simulations. In some examples, there may be more than 25 virtual device simulations. Any one or more of the virtual device simulations can be generated by the simulator device 10 once connected to the network 1 (for example to mimic another device 20 connected to the network 1 other than the simulation device 10 either in appearance, behaviour, and/or otherwise during simulation). Additionally or alternatively any one or more of the virtual device simulations can be pre-programmed into the simulator device 10 prior to be connected into the network 1.

The assumption that a possible network intrusion is present in the network when the simulation device detects data intended for a virtual device simulation means that the simulation device 10 can have a low power rating. That is, the simulation device can operate with a low amount of power, for example a power rating of up to about 250 Watts. Optionally, the simulation device 10 can have a power rating of about 5 Watts. Optionally, the simulation device 10 can have a power rating of about 10 Watts. Optionally, the simulation device 10 can have a power rating of about 20 Watts. Optionally, the simulation device 10 can have a power rating of about 50 Watts. Optionally, the simulation device 10 can have a power rating of about 100 Watts. Optionally, the simulation device 10 can have a power rating of about 150 Watts. Optionally, the simulation device 10 can have a power rating of about 200 Watts. Optionally, the simulation device 10 can have a power rating of about 250 Watts.

The simulator device 10 may comprise a data input connector 108 for receiving data. In some embodiments, the data input connector 108 may be a data input network connector used to connect the simulator device 10 into the network 1. This enables the simulator device 10 to receive data from the rest of the network 1 such as shown in the example of FIGS. 1A and 1B, but it is not essential for the data input connector 108 to be a data input network connector. In the examples shown in FIGS. 1A and 1B, each virtual device simulation 100a-c is connected into the network 1 via the data input network connector. In some embodiments, including the exemplary embodiments that will be described later, the data input connector may be a port, such as for example a data input network port. However, the data input connector may be an antenna in an alternative embodiment.

The simulation device 10 may also comprise one or more other components including a power connector 110, a controller 111 (which may also be referred to as a “processor” herein), a user interface 112 which may include an audio emitter 112a, a push button 112b, a display 112c, or the like. The display 112c may be an alphanumeric display. Additionally or alternatively, the display 112c may be a touch screen. A touch screen may be an additional or alternative feature to the push button 112b.

In addition, the simulation device 10 may also comprise device software 114. The device software 114 may comprise functional modules 116 and a local device database 118. The functional modules 116 may comprise one or more of: a packet sniffer 120, a local on-demand web server 122, an external communications manager 124, a threat detection module 126, a threat response module 128, an alert handler 130, a virtual network communications (module) 132, a monitoring and reporting module 134, and a physical I/O handler 136. While the functions of each of these modules will be described in more detail later, it is noted that:
the virtual network communications module 132 can be configured to generate one or more virtual device simulations 100, preferably prior to simulation of the virtual device simulation/s 100
the virtual network communications module 132 can be configured to simulate one or more virtual device simulations 100
the threat detection module 126 can be configured to detect the possible network intrusion by detecting received data intended for any one or more of the virtual device simulations 100
the threat response module 134 can be configured to respond to the detected possible network intrusion
   While the functional modules 116 are shown in the examples FIG. 1B as being software in nature, any one of these modules can additionally alternatively be hardware in nature. In some cases, any one of these modules may be or comprise a combination of software and hardware components. In some embodiments, any one or more functions relating to any one of the functional modules 116 can be executed by the controller 111.

In some simulation device embodiments, the virtual device simulation may mimic an actual device that is or can be connected into the network with respect to one or more attributes. Some examples of mimicked attributes may include the virtual device simulation exhibiting a substantially similar identifier, chatter noise/activity, or online time-profile (that is the times when a device is online and operational) to that of an actual device. This helps to create an impression that the virtual device simulation is simply another device plugged into the network for the possible network intrusion to interact with (by attempting to make contact for example), thus presenting the virtual device simulation as a virtual decoy.

The virtual device simulation identifier may be similar (but not identical) to an identifier of a device connected into the network. For example, the virtual device simulation MAC address may be similar (but not identical) to a MAC address of a device connected into the network. In another example, the virtual device simulation IP address may be similar (but not identical) to an IP address of a device connected into the network. Referring to FIGS. 1A and 1B by way of example, virtual device simulations 100a, 100b, and 100c may mimic device 20a, while virtual device simulation 100d may mimic device 20b (such that none of the virtual device simulations mimic device 20c). For example, the respective simulation identifiers 102a, 102b, 102c may be substantially similar (but not identical) to identifier 22a of device 20a, while simulation identifier 102d may be substantially similar (but not identical) to identifier 22b of device 20b. In a more specific example, the respective simulation MAC address 104a, 104b, 104c may be substantially similar (but not identical) to MAC address 24a of device 20a, while simulation MAC address 104d may be substantially similar (but not identical) to MAC address 24b of device 20b, and additionally or alternatively, the respective simulation IP address 106a, 106b, 106c may be substantially similar (but not identical) to IP address 26a of device 20a, while simulation IP address 106d may be substantially similar (but not identical) to MAC address 24b of device 20b.

In embodiments where a simulator device generates its own virtual device simulation (for example on the virtual networks communications module 132) prior to simulation, it is preferable that the simulator device generates a virtual device simulation based off an actual device that is connected into a network (which may be referred to as a “device being decoyed” herein). Preferably such that during simulation, the virtual device simulation mimics an actual device with respect to one or more attributes as discussed. For example, the virtual networks communications module 132 can be configured to generate a virtual device simulation identifier (including for example a virtual device simulation IP address and/or a virtual device simulation MAC address) that is substantially similar (but not identical) to an identifier of a device (other than the simulation device) that is connected into the network. In a more specific example, the virtual networks communications module 132 can be configured to generate a virtual device simulation IP address that is substantially similar (but not identical) to an IP address of a device (other than the simulation device) that is connected into the network, and/or the virtual networks communications module 132 can be configured to generate a virtual device simulation MAC address that is substantially similar (but not identical) to an MAC address of a device (other than the simulation device) that is connected into the network. In such embodiments, the virtual network communications module can be configured to scan for other devices connected into the network prior to generating any one or more of the virtual device simulations. This allows the virtual network communications module to ascertain the relevant attribute of the device that the virtual device simulation should mimic.

In some embodiments, the simulation device may comprise or be configured to access a whitelist. As a confirmatory measure, the whitelist can be used to help the simulation device determine whether the possible network intrusion (that the simulation device may detect during the course of operation) is a genuine network intrusion that warrants that a response be taken (such as issuing an alert to the user for example), or whether the possible network intrusion is a sanctioned attempt to interact with any of the virtual device simulation/s simulated by the simulation device (e.g. a sanctioned attempt to make contact). In such embodiments, if an attempt is sanctioned, the attempt can be added to the whitelist such that when the possible network intrusion is detected (for example when it attempts to interact with any of the virtual device simulation/s), the possible network intrusion can be cross-checked against the whitelist. From cross-checking the whitelist (for example by correlating the detected possible network intrusion with the whitelisted attempt), the simulation device is able to determine that the possible network intrusion was sanctioned. In such situation, a response is unwarranted because it is determined that detected possible network intrusion was sanctioned, and therefore benign and/or non-malicious in nature.

Additionally or alternatively, in some embodiments, a possible network intrusion can be confirmed as a genuine network intrusion if it is determined that the possible network intrusion interacts with two or more virtual device simulations.

In some embodiments, the simulation device may be configured to provide a response to the detected possible network intrusion (whether there is a whitelist or not). Some examples of responses may include one or more of: issuing an alert to a user, reporting the detected possible network intrusion, or counter-attacking (such as a local Denial of Service (DoS) attack for example) against the offending device. The offending device could be responsible for the possible network intrusion or is a device already infected by the possible network intrusion and requires being “isolated” from the network and/or the internet. In the case of a countermeasure DoS attack, it is designed to effectively disconnect the offending device from the internet and/or drop access to any other devices on the network. This practically isolates the offending device, giving the user time to stop/slow the attack until the offending device can be physically unplugged from the network and have any infection cleaned by an expert.

While some embodiments of the simulation device 10 can be considered to be a self-sufficient standalone device, there can be other embodiments where extra functionality is desired but is either not found in any of the functional modules 116 or can be used to supplement the functionalities that may be contained in one of the functional modules 116. In such embodiments, the simulation device 10 can be configured to access extra desired functionality provided from an administrative platform 60. In the example shown in FIG. 1A, the simulation device 10 can be configured to access the functionalities from the administrative platform 60 that is hosted on a cloud platform 61 through the internet 50, though the administrative platform can alternatively be hosted in any other location external to the simulation device 10. As will be described in more detail later, the administrative platform 60 may comprise one or more of: a public user portal 62, an administrative application 64, an administrative database 66, and API/s (Application Program Interface/s) 68.

FIG. 1C shows a flowchart of a method 150 of detecting a possible network intrusion in a network. The method comprises steps 152, 154, 156, preferably in the order as described here. Step 152 relates to simulating one or more virtual device simulations. Each virtual device simulation respectively provides a virtual decoy for a possible network intrusion. Step 154 relates to receiving data. Step 156 relates to detecting the possible network intrusion. Detection is done by detecting received data intended for any one or more of the virtual device simulations. In some embodiments, the method may also incorporate a step of generating any one or more of the virtual device simulations at step 151. Step 151 may occur prior to step 152. In some embodiments, the method may also incorporate a step of responding to the detected possible network intrusion at step 157. Step 157 may occur after step 156 is performed.

Thus, from the description above there is provided, in some embodiments, a simulator device 10 for detecting a possible network intrusion in a network 1. The simulator device comprises a virtual network communications module 132 configured to simulate one or more virtual device simulations 100. Each virtual device simulation 100 respectively provides a virtual decoy for a possible network intrusion. The simulator device 10 also comprises a threat detection module 126 configured to detect the possible network intrusion by detecting received data intended for any one or more of the virtual device simulations 100. In some embodiments, the virtual decoy is perceived by the possible network instruction to be an active device 20a-c connected to the network 1, optionally communicating with another device 20a-c. In some embodiments, the virtual network communications module 132 is configured to simulate one or more virtual device simulations 100 by generating chatter on the network 1 for each respective virtual device simulation 100. In some embodiments the virtual device simulation is a simulation of a device connected to the network. In some embodiments the device connected to the network is a device other than the simulator device. In some embodiments, the simulator device 10 further comprises a data input connector 108. In some embodiments, the data input connector 108 is a (data input) network connector for connecting the simulator device 10 into the network 1, such that the simulator device 10 is configured to receive data through the (data input) network connector.

From the description above, there is also provided, in some embodiments, a network 1 comprising one or more simulator devices 10 according to any of the embodiments described in the specification.

From the description above, there is also provided, in some embodiments, a method 150 of detecting a possible network intrusion in a network. The method comprises the step of simulating one or more virtual device simulations (step 152). Each virtual device simulation respectively provides a virtual decoy for a possible network intrusion. The method also comprises the step of receiving data (step 154). The method also comprises the step of detecting the possible network intrusion by detecting received data intended for any one or more of the virtual device simulations (step 156). In some embodiments, the method further comprises the step of generating any one or more of the virtual device simulations. In some embodiments, the method further comprises the step of responding to the detected possible network intrusion.

As will be elaborated later in the specification, one possible advantage (out of other possible advantages) is that the simulation device 10 can provide a computationally efficient option for protecting a network. A further possible advantage (out of other possible advantages) provided by the simulator device 10 is that it can provide a plug-in option for securing a network that the simulator device 10 is connected into. This may be applicable in particular to a network set up for a small or home office environment.

The remainder of the detailed description discusses the various features and functions of the simulation device 10 in more detail. The features and functions that will be described in the rest of the specification are optional (unless context dictates otherwise), and should not be considered essential to performing the simulation device 10. This includes discussion of specific embodiments of the simulation device 10 which are considered to fall in the scope of the more general embodiment of the simulation device 10 discussed above.

### 2. PHYSICAL DESIGN OF THE SIMULATION DEVICE

In some embodiments, the simulation device 10 is a physical appliance. Final dimensions, and industrial design may vary depending on manufacturer and use-case scenario (such as a weather-tolerant or hardened version for remote edge computing scenarios).

In some embodiments, the simulation device contains a general computing processor (such as a System on Chip (SoC) or a generic mother or computer board like an Arduino or Raspberry Pi), non-volatile storage (such as a Secure Digital card or hard drive), a network port, a power port, an optional audio-emitting component (such as a buzzer or a speaker), a human input mechanism (such as a touchscreen, push button or keyboard for example. Preferably, the simulation device comprises display capable of displaying information such as an Internet Protocol address and a password or a full user interface.

Purposes of the display include providing status information and as well as a visual alarm. A purpose of the human interface device is to enable a user interface or a local on-demand web server that can be used to review detected problems and to configure device options without Internet connectivity. A purpose of the Network Port is to enable connectivity between the device and a local area network (LAN) via a standard Ethernet cable.

In some embodiments, the physical chassis contains a circuit board having a central processing unit (CPU) microprocessor that executes program instructions and controls, receives data or instructions from, and sends data or instructions to, the other components of the device.

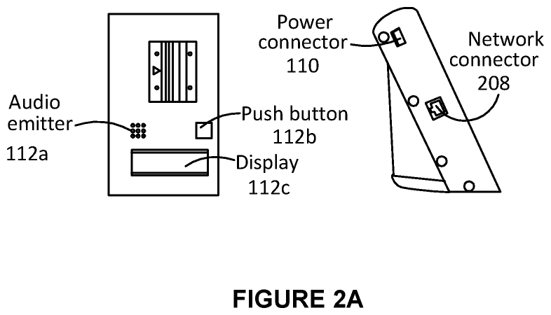

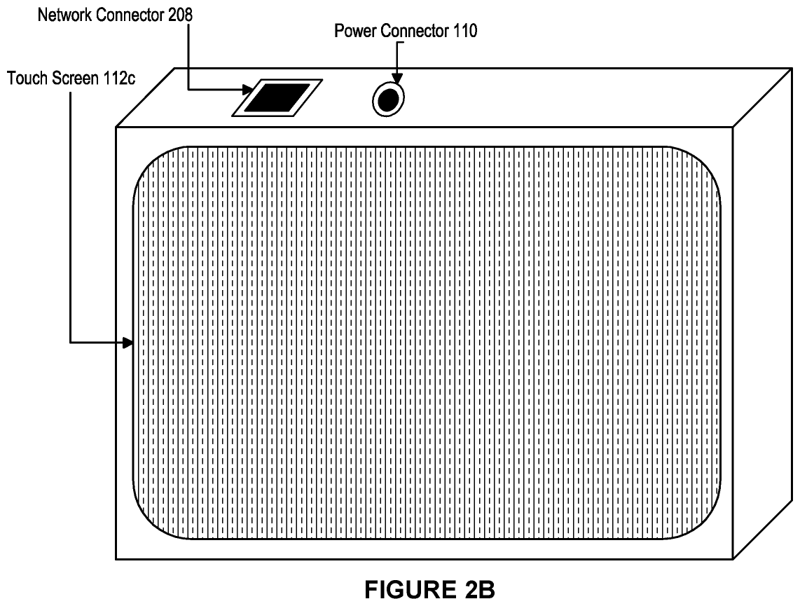

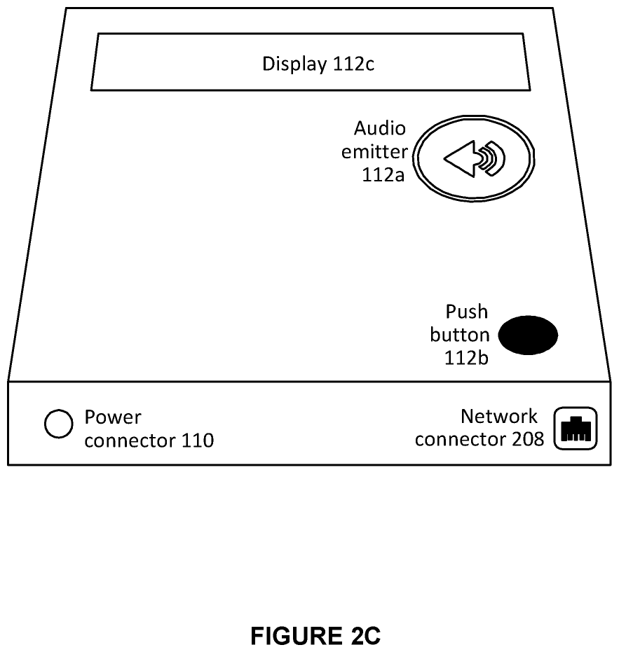

FIG. 2A shows one exemplary embodiment of the simulation device 10. The simulation device 10 shown in FIG. 2A comprises a (data input) network connector 208, a power connector 110, an audio emitter 112a, a push button 112b, and a display 112c. The display 112c is an alphanumeric display.

FIG. 2B shows another exemplary embodiment of the simulation device 10. The simulation device 10 shown in FIG. 2B comprises a (data input) network connector 208, a power connector 110, an audio emitter 112a, a push button 112b, and a display 112c. The display 112c is a touch screen.

FIG. 2C shows another exemplary embodiment of the simulation device 10. The simulation device 10 shown in FIG. 2B comprises a (data input) network connector 208, a power connector 110, an audio emitter 112a, a push button 112b, and a display 112c.

### 3. ELECTRICAL DESIGN OF THE SIMULATION DEVICE

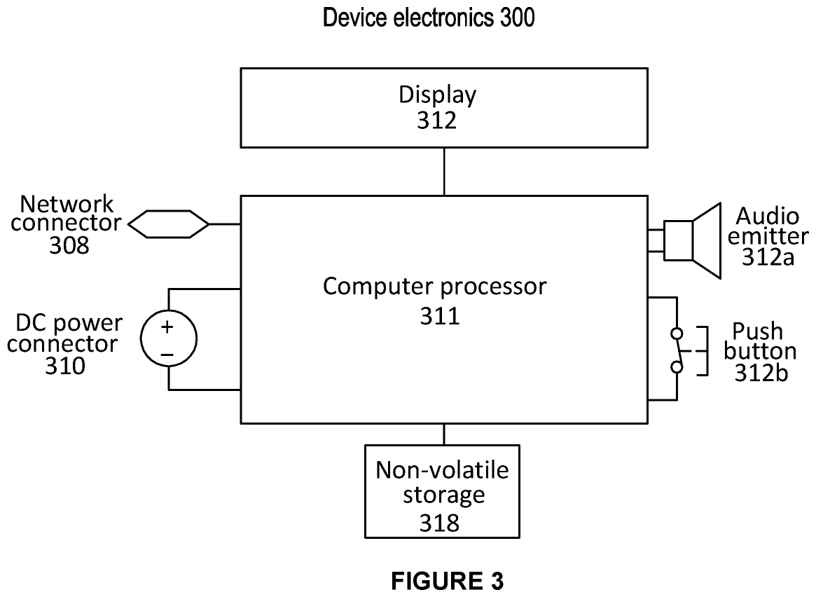

FIG. 3 shows an exemplary circuit board found within the chassis of some embodiments of the simulation device. The circuit board may be found within the chassis of some embodiments of the simulation device. The schematic shown in FIG. 3 is an illustrative diagram of the circuit board (device electronics 300) showing by way of example the relationship between the computer processor 311, the data input connector 308, the (DC) power connector 310, the audio emitter 312a, the human input device, local storage (non-volatile storage 318), and the display 312.

The exemplary embodiment of the circuit board shown in FIG. 3 can be adapted to the physical design of the simulation device 10.

### 4. SOFTWARE ARCHITECTURE

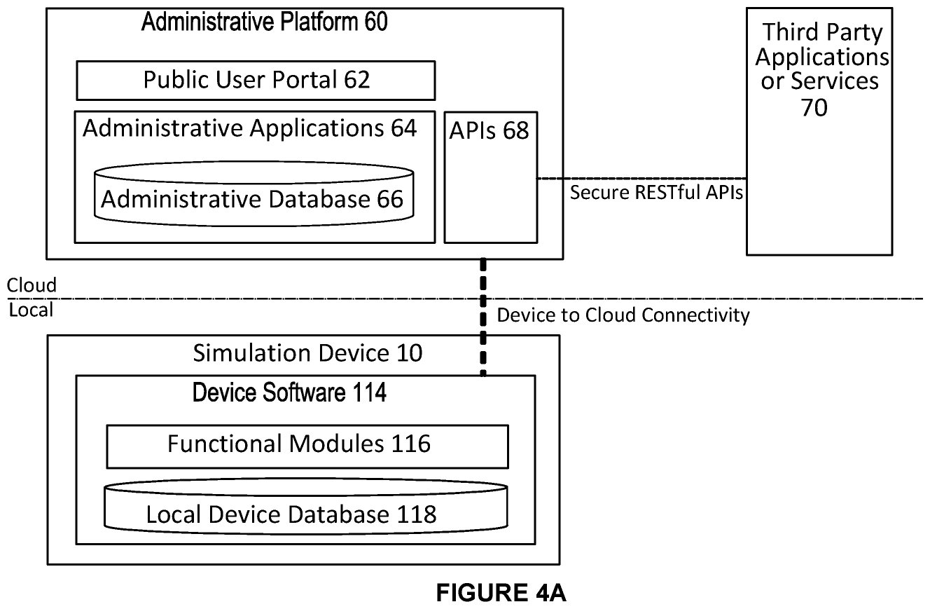

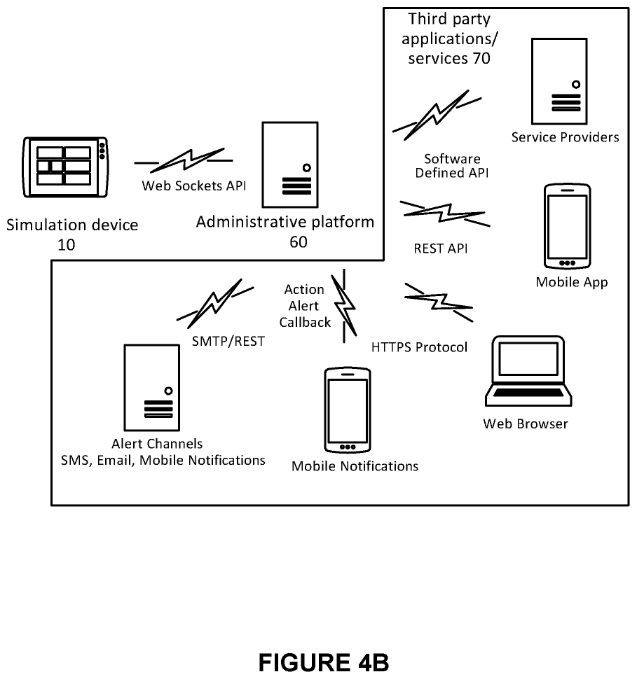

Discussion turns to the solution architecture used in some embodiments of the simulation device 10. Turning to FIG. 4A, the solution architecture includes at least two software layers. The first, and primary, layer of software is loaded and executes directly on the simulation device. This layer can be referred to as the device software 110. While the simulation device is capable of running completely independently and, if required, without Internet connectivity, there is also a remote cloud-based backend software platform with which the device software communicates in some simulation device embodiments. This layer can be referred to as the administrative platform 60.

The simulation device 10 can be capable of running without Internet connectivity, and thus is capable of running without connectivity to the administrative platform 60. This supports challenging use-cases involving segregated networks or remote edge networks where security is still required, but Internet connectivity is unreliable. The simulation device 10 comprises device software 114. The device software 114 comprises functional modules 116 which will be discussed in more detail later. The simulation device 10 may also comprise a local device database 118. The device software 114, including the functional modules 116 may be contained in the local device database 118.

While some embodiments of the simulation device 10 can operate as a stand-alone device, some embodiments of the simulation device 10 can be configured to connect to an administrative platform 60 that supports simulation device administration. The applications of the administrative platform 60 may be accessible from the simulation device 60. For example via a local on-demand web server, or in the case of some embodiments of the simulation device 10, via a touch-screen interface. This local web page may be accessible via an IP address in a standard Internet browser and presented to the user via the display 112c on the simulation device 10 itself in a readable form.

Additionally or alternatively, the administrative platform 60 may be accessible through other means. For example, when the Internet is available, and the user has opted for the additional features available via the administrative platform 60 (hosted on the cloud for example), access to one or more administrative application features 64 is available via a public user portal 62. The administrative platform 60 may be accessible through one or more application programming interfaces (APIs) 68. For example, the API 68 may be a web page accessible over the public Internet via any standard Internet browser for a user to access.

The simulation device 10 establishes secure connectivity to the administrative platform 60 over the public Internet for ongoing administration, configuration, security controls, and software updates. The sections that follow describe both layers of the architecture in more detail.

### 4.1 DEVICE SOFTWARE

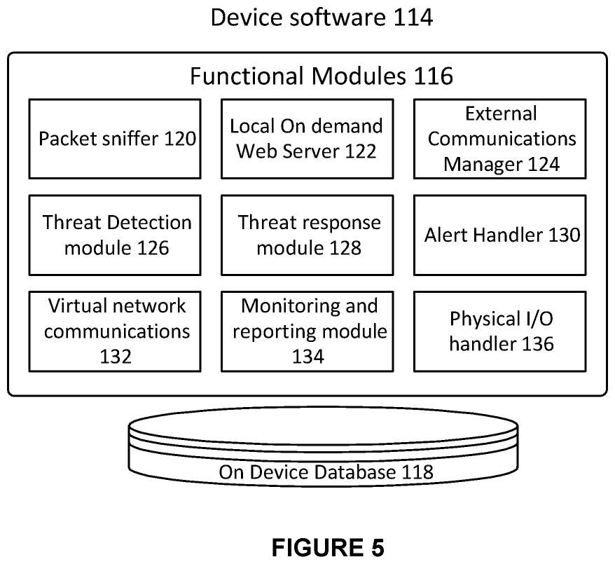

Turning to FIG. 5, some embodiments of the simulation device 10 may comprise device software 114. The device software 116 may include one or more functional modules 116. The device software 114 may be hosted on a device database 118.

Some embodiments of the simulation device can run local software on top of a general-purpose operating system (such as BSD, Windows or Linux). The general-purpose operating system handles all basic operations such as file management, main network connectivity, and the firewall of the simulation device. In some embodiments, the local firewall is enabled from the factory to block all incoming traffic by default.

The functional modules of the device software on the simulation device (as shown in FIG. 5) will now be discussed in turn as follows.

### 4.1.1. PACKET SNIFFER

Some embodiments of the simulation device may comprise a packet sniffer 120. This sub-section describes an exemplary packet sniffer 120. A purpose of the packet sniffer is to “listen” to traffic arriving on the network port of the simulation device. The packet sniffer filters packets so that only broadcast packets or packets destined for the simulation device and/or one of the virtual decoys are forwarded to the threat-detection module, which will be discussed later.

### 4.1.2. LOCAL ON-DEMAND WEB SERVER

Some embodiments of the simulation device may comprise a local on-demand web server 122. This sub-section describes an exemplary local on-demand web server 122. The local on-demand web server is the module that provides user administration without Internet connectivity or access to the administrative platform. The local on-demand web server is responsible for configuration and basic administration of the simulation device via a simple local web browser interface, accessible by any conventional Internet browser on the local network. In some embodiments, the local on-demand web server may respond to hypertext-transfer-protocol (HTTP) requests under one of four conditions:
1. The push button on the physical device has been pushed to start the local on-demand web server; or
2. The external communications manager forwards a request to start the local on-demand web server for remote control; or
3. The local on-demand web server is activated from the touch screen interface of the device; or
4. Less secure (but common in many devices that require administration), the local on-demand web server is always activated.

In some embodiments, the web page of the local on-demand web server may be reached via a conventional Internet browser and a simple IP address presented from the display window of the simulation device. The user enters that same IP address into a web browser. When the local on-demand web server is active, the local on-demand web server serves up content to the user's web browser and responds to user submissions. Content could include for example web pages, images, fonts, scripts, style sheets, and the like.

### 4.1.3. EXTERNAL COMMUNICATIONS MANAGER

Some embodiments of the simulation device may comprise an external communications manager 124. This sub-section describes an exemplary external communications manager 124. The external communications manager orchestrates the traffic, i.e., communications, between the simulation device and the administrative platform. This communication uses web sockets (meaning that communications are bi-directional). The simulation device and the public user portal of the administrative platform authenticate themselves to each other in a conventional manner by digitally signing their communication using their respective private keys and shared public keys.

An advantage of using web sockets is that using web sockets allows the administrative platform to initiate communication with the simulation device even though access to the simulation device is not publicly available on the Internet.

Examples of features that can be implemented using the external communications manager could include, but are not limited to: remote configuration (via a reverse proxy of the local on-demand web server), software updates, remote reset of data to prepare the simulation device for sale or after a theft, remote factory reset of software, advanced alerting via premium channels such as short messaging service (SMS), and advanced alerting via email or mobile phone applications that enables an instant response or action on the simulation device. The advanced alerting can have an embodiment of a message with response options. For example, a message with a response option could be “The device at IP 1.2.3.4 just attempted to connect to port 123 on the domain server decoy. Click here to 1. counter-attack (and/or block), 2. here to monitor, or 3. here to ignore this alert”.

### 4.1.4. THREAT DETECTION MODULE

Some embodiments of the simulation device may comprise a threat detection module 126. This sub-section describes an exemplary threat detection module 126. The threat detection module analyzes the incoming network packets. The threat detection module also evaluates whether the packets constitute a threat (such as attempts to communicate with any virtual device simulations for example). Because the virtual decoys in the simulation device present themselves as multiple attractive ‘targets’ to some or all threats, the threat detection module “assumes” that anomalous attempts to contact a virtual device simulation are possible (high-risk) network intrusions. In some embodiments, white lists can ensure that friendly or known attempts to communicate with a virtual network device are ignored, such as standard device scans of known software in the network. In such situations, the possible network intrusion can then be dismissed as it is determined that possible network intrusion is not a genuine network intrusion. In some embodiments, the simulation device also keeps track of known patterns from standard scans to differentiate threats from regular scans.

If the threat detection module detects a threat, the threat detection module has the option to broadcast an alert via the alert handler and/or instruct the threat response module to take action. If the threat detection module detects no threat, then the threat detection module forwards the one or more received network packets to the virtual network communications.

### 4.1.5. THREAT RESPONSE MODULE

Some embodiments of the simulation device may comprise a threat response module 128. This sub-section describes an exemplary threat response module 128. The threat response module manages how the simulation device responds to a detected threat. A detected threat may constitute be any attempt at communication with one of the virtual device simulations that are instantiated by the simulation device. In some embodiments, the threat detection module detects more than one attempt at communication using different protocols, then the threat response module considers the risk elevated.

In some embodiments, the user has the ability to configure what happens when the threat detection module detects a threat. Some examples of threat responses may include: simply alerting the user, to packet monitoring, and/or deliberately counterattacking the offending device.
For alerting, the threat response module forwards the threat information to the alert handler.
If monitoring has been selected, then the threat response module uses the Address Resolution Protocol (ARP) to deceive the source of the threat into believing that the simulation device itself now owns the actual router Internet Protocol (IP) address. This method of using the ARP is known as a “gratuitous ARP.” Typically when an offending device wants to “know” which IP address has what MAC address, the offending device broadcasts, to the entire network segment, a message that roughly translates to “Who has [IP]? Tell [IP].” This results in the IP address owner of that given IP address responding directly to the requester IP address. However, sending a response to a computing device without even being asked for a response results in the offending device still updating its internal MAC address reference to that IP address and sending all future traffic intended for that IP address to the new MAC address. This is what enables the offending device having its traffic diverted to the simulation device instead of the destination intended by the offending device.
In the case of counterattacking, the simulation device can use the same technique to deceive all other devices on the network (including the router) that the IP address of the source of the threat no longer applies and lives within the simulation device instead. This creates what is known as a Man in the Middle (MitM) attack. All packets intended for any device on the network (or the Internet by way of the router) from the source of the threat will now be routed through the simulation device. The threat response module now can choose what to do with that traffic. For monitoring, it starts up a new, dedicated monitoring and reporting module and forwards all traffic to or from the source of the threat through there. For blocking, the threat response module simply does not respond to any packets from the offending device, causing the threat of the source (the offending device) of the threat to be cut off from the network.

### 4.1.6. ALERT HANDLER

Some embodiments of the simulation device may comprise an alert handler 130. This sub-section describes an exemplary alert handler 130. The alert handler manages the transmission of alerts and any rules set by the user. In situations with no configuration or unavailable Internet, the alert handler sends the alert through the physical I/O handler and flashes the display and/or sounds the audible alarm.

Examples of (alternative) alert options requiring user-specific configuration may include email alerts, mobile-phone alert applications, social-media alerts, and alerts via the external administrative platform, or the like.

### 4.1.7. VIRTUAL NETWORK COMMUNICATIONS

Some embodiments of the simulation device may comprise a virtual network communications module 132. This sub-section describes an exemplary virtual network communications module. The virtual network communications module handles the simulation of several virtual device simulations. The virtual network communications module implements the ability for (a single network port of) the simulation device to appear as more than one, and even many, physical devices. This is achieved by using the conventional Address Resolution Protocol (ARP), the conventional Domain Name System (DNS), the conventional Internet Control Message Protocol (ICMP—aka PING), and (for the local on-demand web server) the conventional Hypertext Transfer Protocol (HTTP).

In some embodiments, when the user first powers on the simulation device, the virtual network communications module initially monitors the network for a period of time (e.g., from a few seconds to several days) and then generates one or more media access control (MAC) addresses that are each unique to the network, yet similar to the MAC addresses of other devices on the network. A MAC address consists of 6 bytes, the first 3 of which typically indicate a specific manufacturer. The virtual network communications module generates the one or more new MAC addresses for the network using the most common MAC prefixes found on the network and random numbers for the rest of the address.

Once new MAC addresses have been determined and generated, the virtual network communications module uses the DNS protocol to obtain virtual IP addresses from the router. This process involves sending, to the router, DNS request packets from each newly generated MAC address and then waiting to be assigned a respective virtual IP address from the Dynamic Host Configuration Protocol (DHCP) server on the router by a return packet, followed by the virtual network communications module sending an acknowledgment of that same return packet to the DHCP server.

Once the virtual network communications module has obtained a respective IP address for each MAC address, the module participates in network traffic like any other device. When someone (or some device) on the network requests which MAC address has one of the obtained virtual IP addresses (using the ARP protocol), the Virtual Network Communications module answers affirmatively with the corresponding MAC address. This ensures that any traffic directed to the virtual network device corresponding to the MAC address will be routed correctly.

The user can optionally and selectively enable a PING response from one of the virtual devices. This uses the ICMP protocol to respond to PING requests and to establish a presence on the network. This is useful to inform other network monitoring devices that the IP address is indeed in use and active.

The user can also allow the embodiment of the device to select further devices to decoy automatically or can manually nominate specific additional devices to impersonate and, for devices that require it, can assign new network names for those new impersonations. When the simulation device is precisely impersonating an existing device, it will monitor and record any broadcast packets from the impersonated device and will periodically perform similar broadcasts (with the network name, IP address and MAC address being the only replaced attributes) to make the impersonation appear real to any network monitoring equipment.

Another function of the virtual network communications module is to enable communications with the local on-demand web server module over the HTTP protocol. Even though the on-demand web server can be implemented directly on the main network interface with less complexity, using one of the virtual device simulations instead can be a better options in some applications. For example, using one of the virtual device simulations can make it difficult (if not impossible) for any network-sniffing software external to the physical network adapter of the simulation device to determine the location on the network of the simulation device and thus increases the security of the simulation device itself.

The virtual network communications module implements the HTTP protocol by having a full Transmission Control Protocol/Internet Protocol (TCP/IP) software stack implementation. The module has this implementation so that the actual communications to the on-demand web server happens using what is commonly known in the art as “sockets.”

### 4.1.8. MONITORING AND REPORTING MODULE

Some embodiments of the simulation device may comprise a monitoring and reporting module 134. This sub-section describes an exemplary monitoring and reporting module 134. The monitoring and reporting module is controlled by the threat response Module and is started for each threat source (IP Address) and runs for a configurable period of time. If more threats from the same source are detected during the monitoring (such as the source of the threat attempting to probe more than one destination), the monitoring can be terminated early by the threat response module, and the protected device is blocked instead.

During the monitoring period, the monitoring and reporting module modifies any incoming packets to update the source or destination MAC address with the actual correct known MAC address of the intended communication. At the same time, the module accumulates information about traffic volume, protocols, and ports accessed and also inspects any DNS request from the threat source to determine which Uniform Resource Locators (URLs) the threat source is attempting to communicate with. The determining with which URLs the threat source is attempting to communicate is performed as a mapping from URL to IP address, which mapping is typically reliable, whereas a mapping from IP address to URL can be unreliable with many IP addresses being served via Content Delivery Networks (CDNs).

During the monitoring, the simulation device can optionally enable live visualization of the collected data.

Once the time period for the monitoring has expired, the monitoring and reporting Module generates a report that can be sent to the user via one of the alerting methods (such as email) or viewed via the local on-demand web server.

### 4.1.9. PHYSICAL I/O HANDLER

Some embodiments of the simulation device may comprise a physical I/O (input/output) handler 136. This sub-section describes an exemplary physical I/O handler 136. The physical I/O (input/output) handler manages the electronic circuitry to interface with the display, audio emitter, and human interface device (For example: push button or touch screen).

As all of these interfaces are outside the scope of most general-purpose operating systems, custom code may be executed to display a message on the display, to send an audible alarm, or to respond to a button press or user interaction with a touch screen.

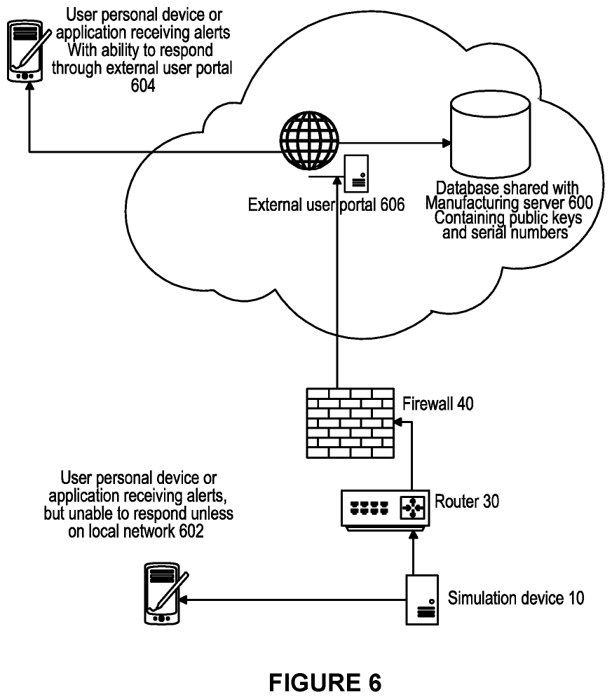

FIG. 6 shows an exemplary embodiment of a simulation device 10 comprising a physical I/O handler module handling all interaction scenarios that might be required during setup or operations. This may include for example, accessing a manufacturing server 600 (which will be discussed in detail later). In some situations an alert may be issued to a user's personal device 602 (which could be through an application) where the user may receive alerts but are unable to respond unless on the local network. In some situations, an alert may be issued to a user's personal device 604 (which could be through an application) where the user may receive alerts with an ability to respond through an external user portal.

### 4.2 ADMINISTRATIVE PLATFORM

In some embodiments, the simulation device may be configured to access an administrative platform 60. Referring back to FIG. 4A, an exemplary embodiment of the administrative platform may include a software application administrative application 64, an Internet-browser accessible public user portal 62, an administrative database 66 and published Application Program Interfaces (APIs) 68 supporting the management of all users and service subscriptions, the administrative configuration of all device behaviors and security levels, and the integration with other third-party applications or communication services.

In an embodiment, the administrative platform may run on public cloud infrastructure, such as is provided by AWS (Amazon Web Services), Microsoft Azure, or Google Cloud Platform.

The Administrative Platform aims to provide a richer set of administration and configuration capabilities than what might be locally available on the simulation device. The administrative platform also enables a single view across multiple devices for larger customers or centralized management across all devices, such as during a local software upgrade. The administrative platform also enables historical archiving of events, advanced intelligence, and other advanced software-enabled capabilities.

When the alert handler issues an alert, the user may not be near the simulation device to log into it. As long as the simulation device is registered on the administrative platform via the public user portal, the user can also log into the administrative platform via the public user portal instead and access all key features on the simulation device (e.g., incident reports, device blocking, manual device monitoring, alert settings, and more).

The public user portal offers structured alert management. It is possible to specify which alerts are sent to whom and under what considerations (e.g., time of day, day of week, severity). Alert options from within the public user portal can include a mobile app, SMS, and email, and call-out to the Application Programming Interface of a remote security monitoring service (e.g. a security operations centre (SOC)).

In addition, the public user portal may optionally offer “Action Alerts”—an additional feature that allows the receiver of operational alerts to initiate immediate actions from the alert itself, whether the alert was transmitted via mobile app, SMS, or email. An Action Alert is an alert that contains a link that the user can click to perform immediate actions without logging into the public user portal. Such actions could include for example: block device/threat, unblock device/threat, mute alert, and so on. This enables rapid response to serious threats when the user is away or when the severity of the threat requires immediate action.

Once the simulation device is registered, it is also able to alert the user to software updates (or the simulation device can be configured to automatically update itself when a new software version is available via the administrative platform).

In addition to these features, the public user portal also offers the options to one or more of the following:
Reset the simulation device password to factory value
Reset the simulation device software to factory value
Reset data to factory values (e.g., erase the simulation device for resale)
Delete Registration of the simulation device

In some situations the administrative platform 60 may also connect to other third party applications or services 70. Turning to FIG. 4B, the administrative platform may be accessible in one or more ways in addition to or alternatively to accessing from the simulation device 10. The administrative platform 60 may be accessible to a service provider (via a software defined API for example). The administrative platform 60 may be accessible on a mobile app (via a REST API for example). The administrative platform 60 may be accessible on a web browser (via HTTPS protocol for example). The administrative platform 60 may also facilitate the issuing of an alert when the simulation device 10 detects a possible network intrusion. For example, the administrative platform 60 may support the pushing of a mobile phone notification alert (via an action alert callback for example). In another example, the administrative platform 60 may support issuing an alert through one or more alert channels (via SMTP/REST for example). Some examples of alert channels may include SMS, email, mobile phone notifications, and the like.

### 4.2.1. SECURE PHYSICAL DEVICE TO ADMINISTRATIVE PLATFORM CONNECTIVITY

In some embodiments, the administrative platform and the simulation device communicate via web sockets, which allow effective two-way communication between the public user portal and the simulation device without the need for the simulation device itself to be exposed to the Internet via an open firewall port.

Web Sockets are simply secure bi-directional communication initiated over HTTPS from a device, in this case, between the simulation device and the administrative platform. The simulation device initiates the connection and stays connected, instead of the public user portal needing to attempt to initiate the connection with the simulation device. The aforedescribed protocol is a conventional form of secure connectivity between remote devices and cloud administrative platforms of all forms.

### 5. GENERATING A VIRTUAL DEVICE SIMULATION

Discussion now turns to various ways of generating a virtual device simulation such that in simulation the generated virtual device simulation poses as a virtual decoy for the possible network intrusion.

### 5.1 SCANNING FOR DEVICES CONNECTED INTO THE NETWORK

The process of generating a virtual device simulation may comprise (in software) of first monitoring what physical devices exists on the network. That is, scanning for devices other than the simulation device that is connected into the network. These physical devices are preferably monitored over a period of time to determine their Media Access Control (MAC) addresses, which other devices they communicate with on the network by monitoring the physical device Address Resolution Protocol (ARP) broadcasts and what time of day and days of the week that the physical devices tends to be online. The Dynamic Host Configuration Protocol (DHCP) broadcasts of the physical devices should also be recorded (if used by the physical device).

### 5.2 DETERMINE NEW MAC ADDRESS

Once a suitable amount of data has been recorded, some embodiments of the simulation device may allocate devices from the network to be decoyed. This can be random, but preferably by prioritizing devices that have a host name (such as a NETBIOS name or a DHCP host name option).

For each virtual device simulation (to pose as a decoy) a new, unique to the network, MAC address is allocated. This can be done preferably by combining the Organizationally Unique Identifier (OUI) component of the MAC address (typically the first 3 bytes) with a random sequence of individual bytes to complete the MAC address. This new MAC address is then checked for uniqueness against the recorded physical devices on the network and any previously allocated virtual device simulation MAC addresses (for a virtual decoy). Should a MAC collision occur, the algorithm will retry until a suitable unique MAC address is found.

### 5.3 DETERMINE A NEW HOST NAME

If the physical device being decoyed has a host name, a new similar (but unique to the network) host name is created for the virtual device simulation. This can be a random set of allowed host name characters, or, in the preferred embodiment of the device, an algorithm that tries to mimic the naming standard used on the network. For example, if the network has such host names as DESKTOP-1R23 and DESKTOP-5F22, a preferred implementation of a new host name algorithm could implement as an example DESKTOP-8D33. This can be done using a machine learning algorithm or simple character pattern analysis.

### 5.4 OBTAINING AN IP ADDRESS

For a newly generated virtual device simulation (to pose as a decoy), a user can manually allocate a “fixed” IP address to the virtual device simulation being generated. Additionally or alternatively, the device software can obtain a virtual device simulation IP address for the virtual device simulation using DHCP.

If a fixed IP address is allocated, no further steps are required and the virtual device simulation (posing as a decoy) can proceed to perform “chatter”, which will be discussed next.

If the IP address for the virtual device simulation is allocated via DHCP, the device software can craft a DHCP Discover packet with its own MAC address and broadcast that packet to the network. The DHCP Discover packet can be just a standard packet, but a preferred implementation is to copy the DHCP packet recorded from the physical device being decoyed and replacing the MAC address and host name. This ensures that the DHCP packet broadcast is very difficult to distinguish from the physical device being decoyed. The software implementation of the decoy then completes the implementation of the published DHCP specification to complete obtaining an IP address.

### 5.5 CREATING “CHATTER”

Once the virtual device simulation is allocated IP address and is online, the virtual device simulation periodically and slightly randomly broadcast Address Resolution Protocol (ARP) packets to IP addresses that the device being decoyed also communicates with—as well as for any other decoys of the same device. This will create the illusion to anyone passively monitoring the network that the virtual device simulation posing as a decoy is indeed an active device communicating with other devices, creating a bigger incentive to attract an attack or more generally attract some other type of possible network intrusion.

### 6. INITIAL MANUFACTURING CONFIGURATION

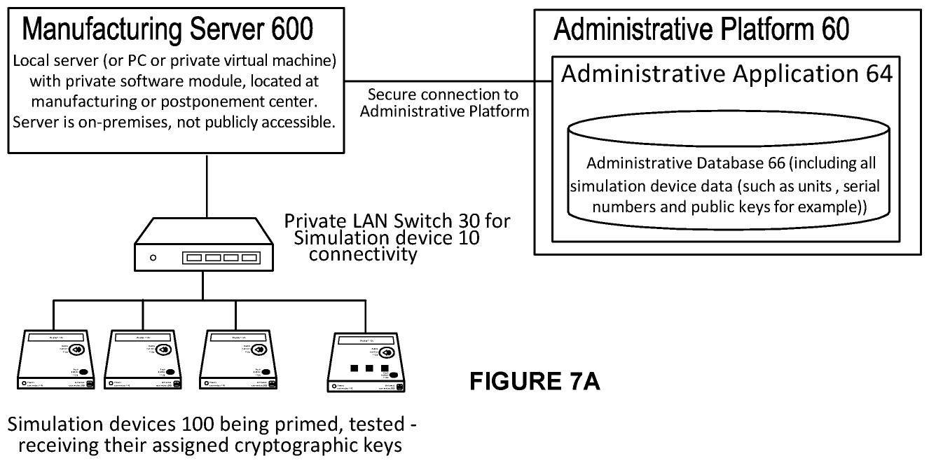

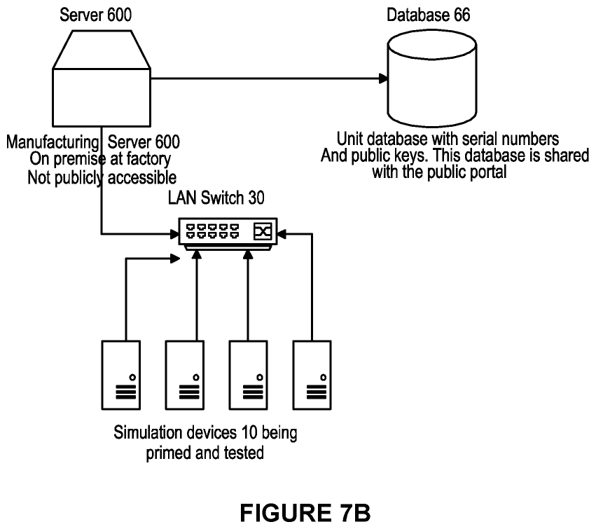

During the manufacturing quality-assurance process, some embodiments of the simulation device 10 may connect to a manufacturing server 600 during manufacture of the simulation device 10. The manufacturing server 600 may be used to assign cryptographic keys to a simulation device 10 or more generally prime/configure or test the simulation device 10 during manufacture. This section describes the manufacturing server 600 by way of example with reference to FIGS. 7A and 7B).

The manufacturing server 600 may be a local server (but alternatively could be a PC or a private virtual machine). The manufacturing server 600 has private software module. The manufacturing server 600 may be located on the manufacturer's premises such as at a factory, manufacturing centre, or postponement centre, such that the manufacturing server 600 is not publicly accessible. Alternatively, the private software module may run on a manufacturing server, which may be a private virtual machine or a local server not publicly accessible, and which is connected to the administrative platform by a secure database connection. In some embodiments, the manufacturing server may connect to or be located within the administrative platform 60.

The manufacturing server 600 may be used to configure the simulation device 10 during its manufacture as follows. One or more simulation devices 10 may be plugged into a switch 630, such as a private LAN switch to connect to the manufacturing server 600. The private software module being run on the manufacturing server 600 may then assign, to each simulation device 10 (configuration) simulation device data. (Configuration) simulation device data may include for example: a unique serial number, a unique initial password, and a unique private and public cryptographic key. Only during the manufacturing process is the manufacturing server 600 accessible to the simulation device 10. The manufacturing server 600 can store the assigned public cryptographic key in a database, such as the administrative database 66 of the administrative application 64 for example. In some embodiments, contents stored in the administrative database 66 may be shared through a public portal.

The cryptographic key plays a role in ensuring all future interactions between any individual simulation device 10 and the central administrative platform 60 are secure, despite traversing the public Internet. This additional manufacturing step also ensures that the simulation device is secure upon purchase and upon initial activation by the user without any user configuration or action.

Such preconfigured simulation device embodiments (e.g., not requiring any user configuration or other user action) are advantageous over other out-of-the-box security solutions as it does not require the user to configure or change any authentication setting on the simulation device for it to be extremely secure. In contrast, prior network security solutions aimed at the small business market set a publicly available or printed default password or key that a user must change after installation. But due to a typical user's unfamiliarity with network security, and with computers and other network components in general, this configuration step required by prior solutions is often not executed by users in the small business market, resulting in significant security vulnerabilities.

### 6.1. PRIMING AND QUALITY ASSURANCE EXAMPLES

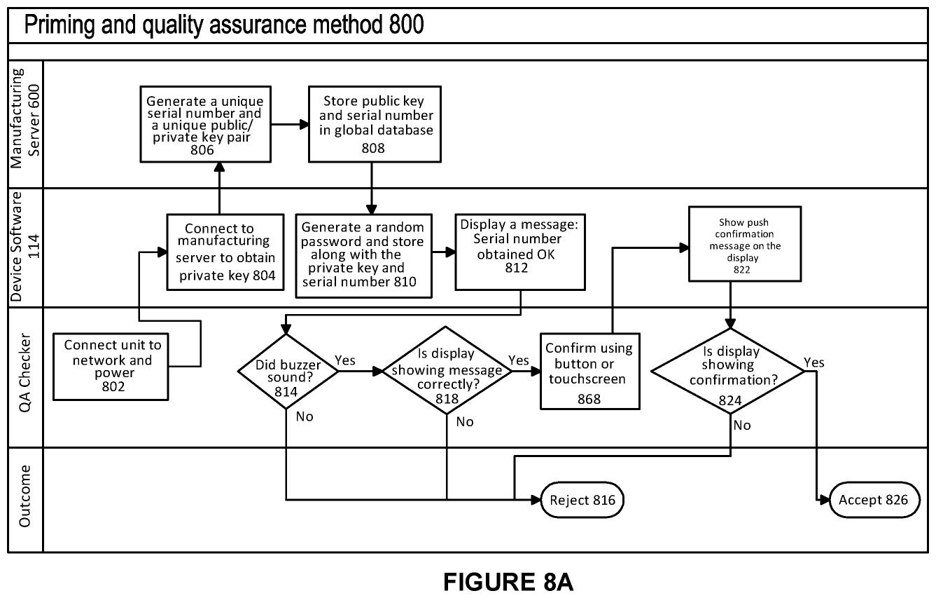

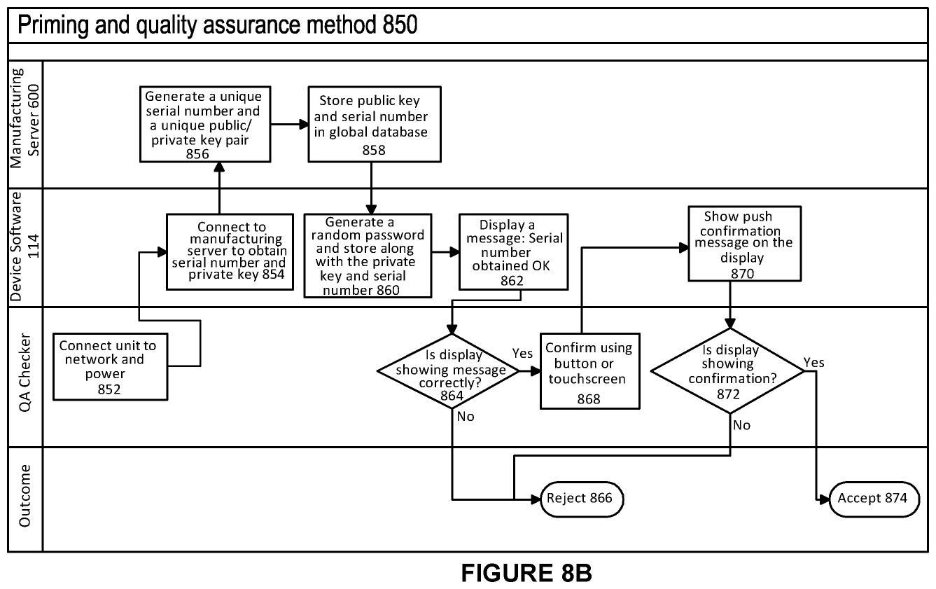

Two exemplary priming and quality assurance methods 800, 850 of configuring the simulation device 10 (at manufacturing stage) using the manufacturing server 600 will now be described with reference to FIGS. 8A and 8B in turn.

FIG. 8A shows a first priming and quality assurance method 800 to configure the simulation device 10. Preferably the method comprises steps 802, 804, 806, 808, 810, 812, 814, 816, 818, 820, 822, 824, and 826 but it is possible that one or more steps may be omitted and it is possible the method steps may be performed in a different order as will be described. At step 802, the quality assurance checker (QA checker) connects the simulation device 10 to network and power. At step 804 the device software 114 connects the simulation device 10 to manufacturing server 600 to obtain a serial number and private key for the simulation device 10. At step 806 the manufacturing server 600 generates a unique serial number and a unique public/private key pair for the simulation device 10. At step 808 the manufacturing server 600 stores the generated public key and serial number of the simulation device 10 in a global database. At step 810 the device software 114 generates a random password and stores it along with the private key and serial number. At step 812 the device software 114 causes a message to be displayed on the simulation device display, such as “Serial number obtained OK”. At step 814 the QA checker checks to see whether a buzzer (for example from the audio emitter of the simulation device) sounds. If the buzzer did not sound, the simulation device 10 is considered defected and is rejected at step 816. If the buzzer did sound, the QA checker checks to see whether the display is showing the message correctly at step 818. If the display is not correctly shown the simulation device 10 is rejected at step 816. If the display is correctly shown, the QA checker proceeds to push the button at step 820. At step 822 the device software 114 shows a push confirmation message on the display of the simulation device 10. At step 824 the QA checker checks to see whether the simulation device display shows a confirmation message. If the display does not shows a confirmation, the simulation device 10 is rejected at step 816. If the display does show a confirmation, the simulation device 10 is ultimately accepted at step 826.

FIG. 8B shows a second priming and quality assurance method 800 to configure the simulation device 10. Preferably the method comprises steps 852, 854, 856, 858, 850, 852, 854, 856, 858, 850, 852, 854, and 856 but it is possible that one or more steps may be omitted and it is possible the method steps may be performed in a different order as will be described. At step 852, the quality assurance checker (QA checker) connects the simulation device 10 to network and power. At step 854 the device software 114 connects the simulation device 10 to manufacturing server 600 to obtain a serial number and private key for the simulation device 10. At step 856 the manufacturing server 600 generates a unique serial number and a unique public/private key pair for the simulation device 10. At step 858 the manufacturing server 600 stores the generated public key and serial number of the simulation device 10 in a global database. At step 860 the device software 114 generates a random password and stores it along with the private key and serial number. At step 862 the device software 114 causes a message to be displayed on the simulation device display, such as “Serial number obtained OK”. At step 814 the QA checker checks to see whether the simulation device display is showing the message correctly. If the display does not show the message correctly, the simulation device 10 is considered defected and is rejected at step 866. If the display does show the message correctly, the QA checker checks for a confirmation using a (push) button or touchscreen on the simulation device 10 at step 868. At step 870 the device software 114 shows a push confirmation message on the display of the simulation device 10. At step 872 the QA checker checks to see whether the simulation device display shows a confirmation message. If the display does not shows a confirmation, the simulation device 10 is rejected at step 816. If the display does show a confirmation, the simulation device 10 is ultimately accepted at step 874.

### 7. IMPLEMENTATION

### 7.1. Initial Installation

The initial installation of the simulation device 10 will be described by way of example with reference to FIG. 9.

FIG. 9 shows a network 901. In this example, network 901 comprises a (Demilitarized zone) DMZ 951. The DMZ 951 comprises a simulation device 910, public server 920a, router 930, firewall 940, modem 955. The network 901 also comprises an intranet (network) 1001. The intranet (network) 1001 comprises simulation device 1010, mobile device 1020a, laptop 1020b, internal server 1020c, wired PC 1020d, a wireless router 1030, and a firewall 1040.

Thus, in the example shown in FIG. 9, there are two simulation devices 910 and 1010 plugged into a network 901.
Simulation device 910 is plugged into router 930. Simulation device 910 is used to protect other devices that connect into the DMZ 951, such as public server 920a. In some embodiments, the simulation device 910 may also protect other devices that are within the intranet network 1001, but in some embodiments, the simulation device 910 may not.
Simulation device 1010 is plugged into router 1030. Simulation device 1010 is used to protect other devices that connect into the intranet (network) 1001 such as a mobile device 1020a, laptop 1020b, internal server 1020c, wired PC 1020d. In some embodiments, the simulation device 1010 may also protect other devices that are within the network 901 but outside the intranet network 1001, but in some embodiments, simulation device 1010 may not.

The simulation devices 910, 1010 may be plugged into one or more conventional network switch ports via a network cable (e.g., network switch ports are usually found at the back of any network wired or wireless router).

The simulation device is configured to be connected directly to one of the available network switch ports directly on the router or combination wireless router and modem. Standard ethernet cabling is sufficient to make the simulation device to router connection.

Once the simulation device is powered on, the simulation device is also automatically activated and ready for secure monitoring of the local network, including threat detection and threat-detection response.

### 7.2. INITIAL REGISTRATION

After the initial installation is complete, the initial registration with the administrative platform takes place via the simulation device's onboard web server providing the administrative platform with a redirect link to the simulation device portal that contains the simulation device serial number. In an embodiment, the serial number is a minimum of 50 characters, structured through a manufacturing timestamp in milliseconds followed by 2 very large random numbers at least 17 characters long. This aims to make the serial number difficult to impossible to guess, even using advanced electronic equipment.

A simulation device can only be registered once at any one time. If the user wishes to sell or transfer the simulation device, he/she first unregisters the simulation device and then the new owner re-commissions it as if it were a new simulation device.

A single user can register more than one simulation device to the same administrative platform account. The user is offered the option to provide a meaningful name (such as “Front Office Gorgon”) to the newly registered simulation device instead of using the serial number so that it is easier to identify in the Public user Portal interface.

Upon registration, the user's phone number and email address may be collected, enabling the simulation device to send SMS or email alerts via the Public user Portal with no further configuration of the simulation device itself. Second-factor authentication via a one-time email password or a QR code to set up Google Authenticator (or similar second factor authentication application) on the user's phone may also be offered for subsequent public user portal logins.

### 7.3. INITIAL USER INTERACTION

To ensure access is limited to only users with physical access to the simulation device or users who have registered the simulation device with the administrative platform, one of several methodologies can be implemented.

In a preferred embodiment of the simulation device, the touch-screen interface presents an optional startup sequence of screens to prompt the user for any additional useful information that applies to the network being protected (such as the local time zone of the device, a fake network name and manufacturer to make the device less obvious on the network and a QR code for the user to optionally register the device with the administrative platform).

Once this initial screen has been completed (or skipped), the embodiment of the device may start learning the network broadcast packets of devices on the network and may also record the comings and goings of devices to profile their online behaviour. After an initial period of learning, the preferred embodiment of the device can automatically assign decoys to as many devices as possible within the limits of the hardware capabilities of the embodiment of the device.

In an alternative embodiment, the simulation device may be fully functional after activation with no configuration, the alarm of the simulation device (representing the discovery of a cyber threat) may trigger the first required user action.

In the case of a detected threat and ensuing alarm, the user touches the human interface on the simulation device to make the alarm stop. Note that advanced configurations through the public user portal of the administrative platform may set alternative or active time windows for the alarm. However, this section presents what happens if an embodiment of the simulation device is activated using a stand-alone configuration and/or without prior configuration.

In a preferred embodiment of the simulation device, the user interacts with the alerts directly from the touch screen user interface. However, if the embodiment of the simulation device has no touch-screen, an alternative is that the display provides the IP address of the simulation device's local on-demand web server and the factory-set random password. The purpose of this process is three-fold:
The IP address is assigned by the router to which the simulation device is connected and is not known before the simulation device is plugged in (hence the reason for displaying the IP address).
The password (which is random) is shown to protect against users who leave default passwords in place (as is often the case for conventional devices).
The local on-demand web server should time out after a few minutes of inactivity (i.e., without any interaction with the local on-demand web server). This means that no one without physical access to the simulation device can attempt to hack, or actually hack, the simulation device during normal operations.

In theory, the simulation device's password could be random for each login attempt, but this has been found to be less usable to the target small-business user. That said, in some embodiments, the simulation device can be configured to randomly generate a password on each login attempt. Such a new-password-per-login protocol may be suitable, for example, for high-security cases.

The user enters the IP address from the Display into a browser (e.g., displayed with a computing machine other than the simulation device) and, in response, is provided with a login page. As public-key cryptography (HTTPS) typically cannot be used with conventional browsers for an IP address (most conventional browsers will block this action or provide security warnings), the user instead enters the password shown on the device display.

This password is used as the secret key for communication between the browser and the simulation device. The initial communication that the computing machine receiving the browser input sends to the simulation device is the password encrypted by itself, and the simulation device then decrypts the received value with the password it has stored locally and confirms that the password entered is indeed correct. If the decrypted password is correct, then the simulation device, in turn, can use that password for authentication and encrypted communication with the browser while in session. The encryption on the browser side happens entirely with JavaScript in the browser, for example, using the AES256 algorithm, which provides complete end-to-end encryption.

If the user logs into the simulation device the first time using the factory-set password, an embodiment of the device prompts the user to choose, optionally, a private password upon login. That is, the simulation device gives the user the option to change the password set at the factory.

In the case where the user has set the user's own password, has forgotten it, and has not registered the device with the external administrative platform (which offers a password reset option), the user can force reset of the password to factory setting by powering off the simulation device and powering the simulation device back on, all the while holding down the button on the simulation device. This will reset the password to the factory default.

However, if the user has enabled external alerting (such as email), this reset only succeeds if the simulation device is also connected to the network. The reason for this is to ensure that a malicious actor with physical access to the simulation device cannot reset the simulation device without the user being notified through an alert sent upon reset.

Alternatively, a user can configure the simulation device such that one can reset the password of the simulation device only via the registration portal (e.g., the administrative platform). This no-hard-password-reset configuration stops people with physical access to the simulation device from performing a surreptitious reset of the simulation device password.

### 8. OPERATIONS

Discussion turns to the operation of the simulation device. In some embodiments, the simulation device becomes operational once plugged into at least one network switch port. Various operations of the simulation device will be discussed in more detail.

### 8.1. ACTIVE DECEPTION

When first plugged in, a user need not manually configure the simulation device for the simulation device to start providing protection. An embodiment of the device automatically scans the network to locate servers and other device types from known manufacturers and creates multiple virtual device simulations that respectively act as multiple virtual decoys. A decoy is a term of art referring to the act of mimicking something else in order to attract cyber threats. Upon activation, the default number of virtual decoys will be one or more depending on the size of the network and the number of devices that will be mimicked.

The administrative platform also allows the more advanced user to configure the number of automated virtual decoys or manually create additional virtual decoys. The total number of virtual decoys may be limited by the physical simulation device hardware and the network itself. Examples of physical limits are CPU processing speeds and network address saturation (most networks have limits of how many devices they can support within their IP address structure).

Each virtual decoy may then mimic an attractive cyber target on the network by emulating the MAC (media access control) address of a known server brand and model (see below). Additionally in some embodiments, using machine learning and statistical analysis, the virtual device simulations (posing as virtual decoys) may monitor the actual behavior of the real devices on the network and start to “behave” in similar but not identical fashion. The desired effect is to appear legitimate without appearing to be a decoy. This is achieved by monitoring start times, active times, down times and ethernet packet broadcasts for other attributes, such as the Dynamic Host Configuration Protocol (DHCP) for the type of connection advertised. DHCP can reveal information such as the speed of the connection, wired versus wireless, and the wireless access point currently being used. The desired effect is to make the virtual decoy mimic a device without being identical to any other actual device on the network. In some embodiments, each virtual device simulation (posing as a virtual decoy) acts as an independent “device” capable of deceiving, detection and responding independently.

### 8.2. INCIDENT DETECTION

In some embodiments, when the simulation device is first plugged in, the simulation device scans the network for existing servers and chooses similar MAC address OUIs (manufacturer codes) so that the virtual device simulations (posing as decoys) are indistinguishable from other devices on the network. Each virtual device simulation (posing as a decoy) in turn uses DHCP to obtain an initial IP address. The user can optionally alter both MAC addresses and assigned IP addresses of the virtual device simulation to within the same fixed IP range as other devices.

As the decoys are completely virtual device simulations only masquerading as (computing) devices, any attempt at communicating with them is considered suspicious. In some embodiments, even a PING will trigger the alarm by default. To make the virtual decoy more enticing to a hacker, it can be configured to respond to a PING so that a hacker will expend more time exploring it, and it can also be assigned a network name that can be used to deceive a hacker into thinking the virtual device simulation they've made contact with is attractive (the virtual device simulation should match the rest of the network's naming standard, so needs to be manually assigned, and could be something like “DATABASE SERVER” or “EMAIL010”).

The user also has the option to nominate specific devices on the network to impersonate. In this case the simulation device monitors the broadcast packets emanating from the device to be impersonated and replay those recordings at random times, with just the name, IP address and MAC address replaced. This provides anyone monitoring the network for broadcasts with the impression that the impersonation is a live active device. Protocols that can be learned and impersonated this way includes (but is not limited to): Link Layer Topology Discovery (LLTD), Dynamic Host Configuration Protocol (DHCP), Address Resolution Protocol (ARP) and the Network Basic Input/Output System (NetBIOS).

In one embodiment, the simulation device device monitors the weekly schedule of devices being impersonated and can restrict the network broadcasting times of the impersonation to the times the impersonated device is likely to be connected to the local network.

### 8.2.1. WHITELISTING EVENTS

In some embodiments, the simulation device may comprise a whitelist. Whitelisting events means to exclude specific events from triggering the decoys to avoid false positives from other network monitoring products. The desired effect from the whitelist feature is that the possible network intrusion detected by the simulation device is ascertained to not be a genuine network intrusion once it is determined that the specific event being detected is whitelisted. Alerts with response options can provide the option to instantly whitelist a device through an alert response.

### 8.2.2. NEW DEVICES JOINING THE NETWORK

An embodiment of the simulation device can optionally send the user alerts when a new device joins the network. This enables the user to block new devices attempting to join a wireless network. A full list of other network devices known to the simulation device can be maintained, and the user can apply a respective name to each such device to make such device easier to identify. For example: “Joe's laptop” is friendlier than a MAC address or IP address.

To assist with identifying other network devices in the first place, the simulation device attempts to obtain the other device's NETBIOS name (network name), DHCP name (client name), DNS name and LLTP name. The simulation device next attempts to obtain the other device's manufacturer's name via the other device's MAC address. All of this information is provided (if available) so the user can have the best possible information to identify a device.

At any time, the user can trigger manual monitoring of a given other network device for a configurable amount of time (for example 10 minutes) and can block/unblock the other network device as well using the on-demand web server or via remote control from the external administrative platform.

### 8.2.3. VULNERABLE DEVICE DETECTION

If a MAC address for a group of vulnerable devices becomes publicly known, the administrative platform can alert the user if there is such a vulnerable device on the user's network. This may be referred to as vulnerable device alerting. The administrative platform is updated on a regular basis with published threat intelligence from multiple sources, and when specific devices are mentioned, the administrative platform updates a local table of vulnerable MAC addresses thus allowing the simulation device or the administrative platform to discover, on the same network of which a simulation device is part, a network device having a vulnerable MAC address, and to trigger an alert in response to such discovery.

### 8.3. INCIDENT RESPONSE

In some embodiments, as soon as any device out of or on the network attempts to communicate with one of the virtual device simulations (posing as decoys), an incident response can be triggered. In one embodiment, a response is an alert to the user that a threat has been discovered. In other embodiments, incident responses may include a combination of multiple alerts and even application event triggers to other applications, such as a security incident management or service management platform running on, or disposed on, the simulation device.

Lastly, after a user has been alerted through which means the user has configured, more advanced responses are also possible in some embodiments, including automatic counter-attacking and reporting. The multiple types of alerting and responses are described in the following sections.

### 8.3.1. ALERTING

In some embodiments, the user has the option to configure one or more alert options as follows:
Local Alarm: This can take the form of an audible alarm or some kind of visual alert on the display of the embodiment of the simulation device.
External Alarm: Other alert options can include (but is not limited to): mobile phone notifications, SMS messages, email alerts and alerts via service provider Application Programming Interfaces.

Some examples of alerting are discussed in more detail as follows. These examples are intended as optional features that some embodiments of the simulation device may comprise.

### 8.3.1.1. EXAMPLES

While an audible alarm on some embodiments of the simulation device can be important to enable instant-on protection, it may be considered a “method of last resort.” Other means of alerting the user or designated technical personnel such as email, SMS, or integration into existing incident management systems such as ITSM Platforms or cybersecurity SIEMs can be configured via the onboard web server post-installation:
Simulation device alarm: If an embodiment of the simulation device is unable to reach the Internet to send a message in any other way (as is the case before any system configuration has been performed), then the simulation device starts sending out the SOS alarm. The alarm automatically stops once the simulation device eventually succeeds in sending an alert some other way (or the user presses the push button to acknowledge and stop the audible SOS alarm). Both messaging and alarms may be utilized in some way because a DoS (Denial of Service) or similar attack on the simulation device may be used to prevent the simulation device from alerting the user via messaging.
Alertzy mobile phone alerts (Android and iPhone): Alertzy is a branded solution providing an easy-to-use messaging and alerting option. It entails a free app to be installed on a mobile device (via both the Apple and Google/Android application marketplaces) and, based on a simple account key (created by the app), can receive alerts. It is anticipated that there may be other similar services supported in the future.
SMTP private alerts: Another alerting option is via a private SMTP server or an ISP-controlled SMTP server. This requires the user to know SMTP accounts, passwords, server names and understand general SMTP security. In some embodiments, accompanying instructions can be included with the simulation device for re-configuring a Gmail account to accept SMTP requests, which may be easier for some people. This option can be suitable for applications in which the user desires an entirely private means of alerting.
Additional alerting and integration options: As another option, the user can register the simulation device with the administrative platform and direct the alerts through that public user portal. In this option, the public user portal acts as an aggregation and management point so that multiple simulation devices can talk to a single aggregation point, which can coordinate more advanced integrations and alerting options. Consequently, the architecture of the administrative platform and of the simulation device can be SMS, email, popular notification platforms such as Slack and Teams, and standard integrations into popular service management platforms such as ServiceNow or cybersecurity SEIM platforms.

Should any other device or process on or off the network attempt to communicate with one of the network servers without the network detecting it, the other device would also likely be communicating with a corresponding one of the virtual device simulations (posing as virtual decoys). In response to such communication with one of the virtual decoys the simulation device detects a problem, and in response to detecting a problem, sounds an audible and/or a visual alarm. For example, an embodiment of the simulation device sounds a relatively loud buzzer and flashes the (alphanumeric) display's backlight signals to signal “SOS” in Morse code. The simulation device also, (via the (alphanumeric) display), prompts the user to press the push button on the simulation device. Pressing the push button causes the simulation device to provide a specific address for the user to login to an administrative portal (website) via a standard Internet browser run on another device on the network. This website is presented via an onboard web server on the simulation device, allowing for local access without the Internet.

Furthermore, in an embodiment, the simulation device automatically redirects network traffic through the device for a period of time, for example, 10 minutes (see below), to be able to provide detailed insights into the kind of connection attempts the offending device is performing or attempting to perform. The simulation device provides to the User via the Alphanumeric Display a detailed report and an option to block the offending device from the network and access to the Internet via the network.

Although, as described above, the simulation device is operational without a user manually entering configuration data, in an embodiment, the simulation device allows a user to enter data that causes the simulation device to have more advanced configurations, including routing of alerts to alternative methods (e.g., email or text message) or via REST API integration into a cyber-management or service-management application platform. REST (“Representational State Transfer) is an architectural style for an API (“Application Program Interface”) that uses HTTP (“Hypertext Transfer Protocol) requests to access and use data.

### 8.3.2. AUTOMATIC COUNTER-ATTACKING AND REPORTING

If desired by the user, some embodiments of the simulation device may also trigger what is known as a Man in the Middle (MitM) attack against the offending device, specifically using a technique known as ARP spoofing that redirects all traffic between the offending device and other devices on the network through the embodiment of the device. This enables the full traffic analysis that eventually appears in the user's reports after a specific amount of monitoring time. In an embodiment, the default monitoring time is 10 minutes, after which an email with the actual report or a “Report completed” message is sent to the user.

The generated report contains information about which devices the offending device attempted to communicate with, port numbers, traffic volume, and, for the public Internet, also host names.

From the simulation device's onboard web server or via the administrative platform, the user (or designated cyber/network security team) can then review the report and choose to perform one or more of:
Instantly (or nearly instantly) block the traffic from the offending device to other network devices by changing the ARP spoofing from a MitM to a counterattack, meaning the offending device will be fully isolated.
Forward the report to a security professional for review.
Enable another 10-minute monitoring period for the simulation device.
Discard the report.

The user can optionally enable automatic counterattacking of the offending device upon an alert. However, this could have unintended consequences and may be suitable only within networks of organizations that have a person with network expertise (e.g., an Information Technology (IT) professional). Such automatic blocking also stops the simulation device from analyzing any traffic from the offending device and could be counterproductive from a threat-assessment perspective. Such automatic blocking of the offending device may, for example, kick any security professional with a vulnerability scanner off of the network post haste.

### 9. ADVANTAGES

Based on the various embodiments of the simulation device as described, one or more advantages may be realised as follows:
The simulation device provides a plug-in option for use in a network, such as a local computing network for example, where the user may be inexperienced with cybersecurity measures. The inexperienced user may simply plug in the simulation device to provide protection to other devices connected into the network.
Due to the computational efficiency of the virtual device simulations described in this invention, a very large number of virtual simulation devices can be provided in a low cost and/or low power package. For example, in laboratory testing, the simulation device 10 was found to consume just 10 Watts of electrical power can easily manage to keep 25 virtual simulation devices online concurrently. This low power consumption enables the solution to be deployed in low cost, fan-less enclosures that are compatible with a home office or small business environment. The computational efficiency of the simulation device 10 is due the premise that the virtual device simulations are supposed to be left untouched, such that if the simulation device 10 detects data intended for a virtual device simulation it can be assumed that a possible network intrusion is present. Such premise allows the simulation device 10 to use relative little computational resources. Even in the embodiments where the simulation device 10 responds to the detected possible network intrusion, (such as for example issuing an alert or report, packet monitoring, packet blocking, or counter-attacking generally), the simulation device 10 at bests “isolates” the source of the detected possible network intrusion from the network, which also takes up relatively little computational resources. In contrast, the nature of conventional approaches such as a virtual machine or a TCP/IP server means that detection of a possible network intrusion necessarily entails that these devices engage with the source of the possible network intrusion to “keep it busy”, which requires high-end hardware, but is also more computationally intensive than the simulation device 10. The simulation device 10 can therefore provide a solution in the form of a fan-less device that sits on a desk (or hangs on the wall) and/or is non-intrusive and/or is cheap to run.
The ability to counter-attack an intruder or a compromised real device provides a unique ability for users with no real cyber security understanding to react to an emerging threat and take proactive measures until a cyber professional can alleviate the intrusion.
The concepts of virtual device simulations posing as virtual decoys and optionally responding (such as counter-attacking for example) are easily understood by non-technical people, drastically increasing the value to the inexperienced user. This contrasts with cyber intrusion products designed for cyber professional that are often highly technical and complex to install and maintain.

### 10. DISCLOSED FEATURES

1. A physical device configured to provide security to a network.

2. The physical device of clause 1, comprising an alarm.

3. The physical device of clause 1 or 2, comprising a push button.

4. The physical device of any previous clause, comprising a network connector.

5. The physical device of any previous clause, comprising a visual display.

6. The physical device of any previous clause, comprising an alphanumeric display.

7. The physical device of any previous clause, comprising a memory.

8. The physical device of any previous clause configured to generate a virtual server.

9. The physical device of any previous clause configured to generate a virtual server having a respective MAC address.

10. The physical device of any previous clause configured to detect an offending device connected to the network.

11. The physical device of any previous clause including one or more of a package sniffer, local on-demand web server, external communications manager, threat detection module, threat response module, alert handler, virtual network communications, monitoring and reporting module, physical input-output handler, and a local device database.

12. An administrative platform configured to communicate with a physical device configured to provide security to a network.

13. An administrative platform including a public user portal.

14. An administrative platform configured to run an administrative software application.

15. An administrative platform including an administrative database.

16. An administrative platform including one or more application program interfaces.

17. A method for securing a network.

18. A method for identifying an offending device connected to a network.

19. A method for identifying an offending device that is part of a network.

20. A method for responding to a threat presented by an offending device to a network.

21. A network including a physical device.

22. A network including a physical device and connected to an administrative platform.

23. A physical device configured to provide security to a network without first being configured by a user.

24. A method including using machine learning, statistical analysis, or both machine learning and statistical analysis, to monitor an actual behavior of a real device on a network; and causing a virtual decoy to behave similarly, but not identically, to the real device. From the foregoing it will be appreciated that, although specific embodiments have been described herein for purposes of illustration, various modifications may be made without deviating from the spirit and scope of the disclosure. Furthermore, where an alternative is disclosed for a particular embodiment, this alternative may also apply to other embodiments even if not specifically stated. Moreover, one or more components of a described apparatus or system, or one or more steps of a described method, may have been omitted from the description for clarity or for another reason. In addition, one or more components of a described apparatus or system that have been included in the description may be omitted from the apparatus or system, and one or more steps of a described method that have been included in the description may be omitted from the method.

It is understood that functions and operations described as being performed by software are performed by hardware, such as a controller (e.g., a microcontroller, or microprocessor), executing the software. Furthermore, it is understood that functions and operations described as being performed by software can be performed, instead, by hardware, firmware, one or more field-programmable gate arrays (FPGAs), one or more controllers, or a combination or subcombination of one or more of hardware, firmware, FPGAs, and controllers.

Throughout this specification and the claims which follow, unless the context requires otherwise, the word “comprise”, and variations such as “comprises” or “comprising”, will be understood to imply the inclusion of a stated integer or step or group of integers or steps but not the exclusion of any other integer or step or group of integers or steps.

The reference in this specification to any prior publication (or information derived from it), or to any matter which is known, is not, and should not be taken as, an acknowledgement or admission or any form of suggestion that that prior publication (or information derived from it) or known matter forms part of the common general knowledge in the field of endeavour to which this specification relates.

1. A simulator device for detecting a possible network intrusion in a network, comprising:
a virtual network communications module configured to simulate one or more virtual device simulations, each virtual device simulation respectively providing a virtual decoy for a possible network intrusion; and
a threat detection module configured to detect the possible network intrusion by detecting received data intended for any one or more of the virtual device simulations.

2. A simulator device according to claim 1 wherein the virtual decoy is perceived by the possible network instruction to be an active device connected into the network, optionally communicating with another device.

3. A simulator device according to claim 1 wherein the virtual network communications module is configured to simulate one or more virtual device simulations by generating chatter on the network for each respective virtual device simulation.

4. A simulator device according to claim 1 wherein the virtual device simulation is a simulation of a device connected into the network.

5. A simulator device according to claim 4 wherein the device connected into the network is a device other than the simulator device.

6. A simulator device according to claim 1 wherein there are more virtual device simulations than there are devices connected into the network.

7. A simulator device according claim 1 wherein the virtual network communications module is configured to simulate a plurality of virtual device simulations concurrently, optionally up to 25 virtual device simulations.

8. A simulator device according to claim 1, wherein the simulator device has a low power rating, optionally a power rating of about 10 Watts.

9. A simulator device according to claim 1 further comprising a data input connector.

10. A simulator device according to claim 9 wherein the data input connector is a data input network connector for connecting the simulator device into the network, such that the simulator device is configured to receive data through the data input network connector.

11. A simulator device according to claim 1 wherein the simulator device is further configured to respond to the detected possible network intrusion.

12. A simulator device according to claim 1 wherein the simulator device further comprises a threat response module configured to respond to the detected possible network intrusion.

13. A simulator device according to claim 12 wherein the threat response module is configured to respond by any one or more of: issuing an alert; packet monitoring; and packet blocking.

14. A simulator device according to claim 12 wherein the threat response module is configured to respond by counter-attacking the detected possible network intrusion, optionally using a Denial of Service counter-attack.

15. A simulator device according to claim 1 wherein the at least one of the one or more of the virtual device simulation comprises a respective virtual device simulation identifier.

16. A simulator device according to claim 15 wherein the respective virtual device simulation identifier is similar to an identifier of a device connected into the network.

17. A simulator device according to claim 16 wherein the respective virtual device simulation identifier is not identical to the identifier.

18. A simulator device according to claim 15 wherein at least one of the one or more of the virtual device simulation identifier is or comprises a respective virtual MAC address and/or a respective virtual IP address.

19. A simulator device according to claim 18 wherein the respective virtual MAC address is a similar to an MAC address of a device connected into the network.

20. A simulator device according to claim 19 wherein the respective virtual MAC address is not identical to the MAC address of the device connected into the network.

21. A simulator device according to claim 18 wherein the respective virtual IP address is a similar to an IP address of a device connected into the network.

22. A simulator device according to claim 21 wherein the respective virtual IP address is not identical to the IP address of the device connected into the network.

23. A simulator device according to claim 16 wherein the device connected into the network is a device other than the simulator device.

24. A simulator device according to claim 1 further comprising a packet sniffer for filtering received data received by the simulator device via the network connector.

25. A simulator device according to claim 24 wherein the packet sniffer is configured to filter through received data intended for any one or more of the virtual device simulations.

26. A simulator device according to claim 25 wherein the packet sniffer is configured to filter through data by:
intercepting received data; and
forwarding received data to the threat detection module for data analysis.

27. A simulator device according to claim 26 wherein the possible network intrusion is detected following a determination by the threat detection module.

28. A simulator device according to claim 1 wherein the simulator device is further configured to generate any one or more of the virtual device simulations.

29. A simulator device according to claim 1 wherein the virtual network communications module is further configured to generate any one or more of the virtual device simulations.

30. A simulator device according to claim 28 wherein any one or more of the generated virtual device simulations is generated based on a device connected into the network.

31. A simulator device according to claim 30 wherein the device connected into the network is a device other than the simulator device.

32. A simulator device according to claim 30 wherein the virtual network communications module is further configured to scan for one or more other devices connected into the network in order to generate any one or more of the virtual device simulations that is generated based on the device connected into the network.

33. A simulator device according to claim 30 wherein the virtual network communications module generates any one or more of the virtual device simulations using machine learning to learn behaviour of the device connected into the network.

34. A simulator device according to claim 28 wherein the virtual network communications module generates any one or more of the virtual device simulations comprising a step of generating a virtual device simulation identifier for the respective virtual device simulation.

35. A simulator device according to claim 34 wherein the virtual device simulation identifier is or comprises a MAC address and/or IP address for the respective virtual device simulation.

36. A simulator device according to claim 35 wherein the MAC address is generated based on one or more MAC addresses of the respective one or more devices connected into the network.

37. A simulator device according to claim 36 wherein the generated virtual MAC address is a similar to an MAC address of a device connected into the network.

38. A simulator device according to claim 37 wherein the generated virtual MAC address is not identical to the MAC address of the device connected into the network.

39. A simulator device according to claim 36 wherein the IP address is generated based on one or more IP addresses of the respective one or more devices connected into the network.

40. A simulator device according to claim 39 wherein the respective generated virtual IP address is a similar to an IP address of a device connected into the network.

41. A simulator device according to claim 40 wherein the generated virtual IP address is not identical to the IP address of the device connected into the network.

42. A simulator device according to claim 36 wherein the device connected into the network is a device other than the simulator device.

43-49. (canceled)

50. A network comprising one or more simulator devices according to claim 1.

51. A method of detecting a possible network intrusion in a network comprising the steps of:
simulating one or more virtual device simulations, each virtual device simulation respectively providing a virtual decoy for a possible network intrusion;
receiving data; and
detecting the possible network intrusion by detecting received data intended for any one or more of the virtual device simulations.

52. The method according to claim 51 further comprising the step of generating any one or more of the virtual device simulations.

53. The method according to claim 51 further comprising the step of responding to the detected possible network intrusion.

54. The method according to claim 53 wherein the step of responding is or comprises counter-attacking the detected possible network intrusion, optionally using a Denial of Service counter-attack.

55. The method according to claim 51 wherein the virtual device simulations are being simulated concurrently on a low powered device, preferably with a rating of up to about 250 Watts, more preferably with a power rating of about 10 Watts.
